(19) United States
(12) Patent Application Publication
(10) Pub. No.: US 2017/0182406 A1
(43) Pub. Date: Jun. 29, 2017

(54) ADAPTIVE GROUP INTERACTIVE MOTION CONTROL SYSTEM AND METHOD FOR 2D AND 3D VIDEO

(71) Applicant: AUDIENCE ENTERTAINMENT LLC, New York, NY (US)

(72) Inventors: Clilly CASTIGLIA, Brooklyn, NY (US); Andre ALMEIDA, Almada Setubal (PT); Mac CAULEY, Brooklyn, NY (US); Xavier FAURE, Almada (PT); Ruben Miguel Silva MONTEIRO, Seixal (PT); Manuel Ricardo Fonseca COSTA, Lisboa (PT); Filipe Manuel Miranda da CRUZ, Almada (PT)

(73) Assignee: AUDIENCE ENTERTAINMENT LLC, New York, NY (US)

(21) Appl. No.: 15/127,298

(22) PCT Filed: Mar. 16, 2015
(86) PCT No.: PCT/US2015/020754

§ 371 Date: Sep. 19, 2016

Related U.S. Application Data
(60) Provisional application No. 61/968,483, filed on Mar. 21, 2014.
(60) Provisional application No. 62/068,368, filed on Oct. 24, 2014.

(51) Int. Cl. A63F 13/213; H04N 21/4223; G06T 7/269; A63F 13/42; G06K 9/00

(52) U.S. Cl. CPC A63F 13/213; A63F 13/42; G06K 9/00335; G06K 9/00778; G06T 7/269; H04N 21/4223; A63F 2300/1093; A63F 2300/6045

(57) ABSTRACT

Adaptive system and method for interacting with and navigating 2D and 3D audiovisual content by interpreting the side to side and/or up and down physical gestures and sounds of a multi-person audience. The system may be used in a movie theatre, stadium, music arena, or other venue where an audience views the same view screen. A camera pointed at the audience captures audience motion and a microphone captures sounds. Optical flow is determined by comparing successive video frames. A Motion Index between −100 and 100 is calculated using Optical flow, comparing more recent Optical Flow vectors with previous values. Methods are provided to give equal weight to audience members closer to and further from the camera. Motion Index Values are used to control and interact with content scenarios.

### RELATED APPLICATIONS

This application claims priority to and the benefit of U.S. Provisional Patent Application 61/968,483, filed Mar. 21, 2014, and U.S. Provisional Patent Application 62/068,368, filed Oct. 24, 2014. Both are fully incorporated by reference.

### FIELD OF THE INVENTION

This disclosure is in the field of image processing and sound capture with topical application to interactive applications. It also relates to interactive content involving groups of any size interacting with, as opposed to passively watching, live, pre-recorded and animated content displayed for all types of display applications (e.g., movie screens, stadium/large venue monitors, LCD TV's and monitors in homes and public areas, PCs and PC monitors, and mobile phone displays) and on all display screen types (including LCD, Plasma display, LED display, Projection screen, and any display device that can display digital content now or in the future). The invention also relates to analysis of captured sound and motion data as it applies to crowd response to, and interactive control of, interactive live performance or prerecorded content providing, and approximate calculation of size of crowd and/or their emotional and physical response to that content. This disclosure and invention also relate to group navigation tools in a system referred to generally as “AEIS”—the Audience Entertainment Interactive Server. Related U.S. patent application Ser. No. 13/601,164, filed Aug. 31, 2012 and now U.S. Pat. No. 8,965,048, and U.S. Provisional Patent Application No. 61/530,754, filed Sep. 2, 2011, relate to early embodiments of the AEIS system and are fully incorporated by reference herein as if they were set forth in their entirety, and form a part of this disclosure.

### BACKGROUND

Optical flow estimation is a known way to perform motion detection in a scene by comparing different frames, and can be used as control means for computer-based applications. This invention goes beyond current approaches by specifying a particular method of dealing with detected motion, which is proportional to the perceived universe of motion. In addition, sound detection, particularly vocalized sound (i.e. any noise produced by the group) has been another historical way for groups to voice their expressions of the experience they are involved in collectively. Declaratives for help, yes, no, numbers, cheers of excitement are examples of this.

Technological advances in Still Camera and Video Camera hardware have made panoramic and 360° still photography and video capture a more viable option for content creation, above and beyond traditional 2D video which remains the industry standard. For example, the CENTRO camera creates 360° footage in real time. The 360Cam™ from Giroptic™ uses three 185° fish-eye lenses to take 360° pictures and video, including up to 150 degrees of vertical capture. Various GOPRO® camera products have also been used to create panoramic and 360° content. 360° panoramic stitching software can be used with various camera arrangements.

There is also growing list of 3D content creation tools available to creative communities in game design, architecture and cinematography. Game designers and filmmakers are using panoramic and 3D content in their creative endeavors. 3D content with complex, fully realized story worlds as depicted in video games today have become more accessible to the creative community via popular 3D software programs like Unity3D™, Maya® and Studio Max™. Unity™ is a cross-platform game creation system developed by Unity Technologies, including a game engine and integrated development environment (IDE). Unity is used to develop video games and other content for web sites, desktop platforms, consoles, and mobile devices.

While the available body of 3D content continues to expand and flourish, there are still relatively few options for users navigating this content. There are very few options, assuming there are any, for group navigation of 3D content and virtual worlds.

A 360° scenario refers to a virtual world, live and prerecorded footage or panoramic photos, which surrounds the user on all sides, so that they can turn and see what is next to them or behind them. This will also usually be a 3D scenario, where the virtual world includes spaces above and below the user, in addition to surrounding the user on all sides. This is in contrast to a standard 2D movie or TV program where users typically see only a single screen in front of them, and cannot control which way they are looking. Typically, to properly view a 360° scenario, a viewer must either use a physical input device (such as computer mouse or video game controller) in combination with a single user virtual reality headset, such as the Oculus® Rift. Single user headset based viewing systems allow viewers to explore 360° scenarios. Alternatively, 3D or “virtual world” content can be viewed on large screens available in theaters. With large screens, however, the footage is presented in a passive viewing situation—i.e. with the audience sitting and watching a scene from a pre-determined view, as selected by the creative producer of the content.

Patent references providing background for this invention include the following:

U.S. Pat. No. 8,875,212 describes a system and method for controlling interactive video, including a remote control device for use in interacting with the video.

U.S. Pat. No. 8,903,795 describes a system and method for automating the creation of an episode of a show including an interactive video production. The production can include an interactive music video show.

U.S. Pat. No. 8,776,140 discloses a particular method and system to permit TV viewers to interact with program content broadcast over a subscriber network, such as cable, satellite, internet, or cellular telephone. The details of the ability for the viewer to interact is embedded as data in the program signal. The subscription provider broadcasts a visual indicator as a small icon during programming that informs the viewer that interaction is permitted. The viewer then uses a remote control to purchase products, vote on events, respond to polls, download files, request information, and request callback actions. The TV viewer uses the remote control to send information to a set-top box front-end application, and to iteratively create transactions that are batched and then sent to a back-end core application and database which then handles fulfillment.

U.S. Pat. No. 8,847,887 describes a method and apparatus for interactive TV camera based games in which position or orientation of points on a player or of an object held by a player are determined and used to control a video display. Both single camera and stereo camera pair based embodiments are disclosed, preferably using stereo photogrammetry where multi-degree of freedom information is desired. Large video displays, preferably life-size may be used where utmost realism of the game experience is desired.

### SUMMARY OF THE INVENTION

This invention includes improved methods and arrangements for adaptive motion capture for multi-person audiences, and for controlling either 2D or 3D video using audience motions such as side to side arm movements and/or up and down arm movements. These include improved methods for calculating Motion Indexes using adaptive methods, for dividing the audience into control zones, for dividing the audience into partition zones, and for applying masks and filters, as elaborated below. Each of these techniques is for improving group motion capture results for interactivity.

The instant invention includes presenting 3D audiovisual content or “scenarios” to large groups of viewers, and to those viewers interacting with and collectively navigating the 3D scenarios using physical motions such as moving their arms left, right, up, or down. For example, the audiovisual content can be a 3D virtual city displayed on a movie screen from a first person vantage point which the audience collectively navigates through. The audience can turn left or right by physically gesturing in each direction, or may look straight forward in order to move forward and/or interact with an item which is in front of them. The audience members' collective physical motions are captured by a camera and processed by the system into a single value or “Motion Index” which is constantly updated and which is used as an input to control the 3D movie, game, or other content.

This disclosure will describe methods that enable interactive crowd controlled navigation through 360 degree, 3D scenarios using group motion capture, in addition to methods for single-axis group navigation through more structured content and scenarios. Typically an audience is viewing one or more viewing screens, such as in a theatre, stadium, music venue, or other public area, showing them a virtual scenario. The screen might show a view of a virtual landscape from a first person point of view. Examples of 3D scenarios from a first person perspective include looking out into a 3D city, over a steering wheel at a racetrack, or down from a virtual hot air balloon. Alternatively, the audience might see and control a 2D or 3D character or icon from a second person perspective, perhaps steering a bobsled or cartoon character from a point of view above or both behind and above the character or icon.

Non-limiting examples of scenarios incorporating audience control include controlling action in a movie trailer, in a short content movie, in a full length movie with choices of story breaks and endings.

At least one camera connected to a computer system is aimed at the audience and captures the physical motions of the audience. The AEIS system compares and translates successive images of the audience members' individual motions, typically into a instruction to rotate left, rotate right, or look forward, which in turn controls the action on the viewing screen(s). This instruction is preferably a continuously updated Motion Index having a value between −100 and 100 which is used to control 2D and/or 3D scenarios. Preferred methods for translating images of the audience into instructions for controlling a 3D audiovisual scenario is explained in detail below. In preferred embodiments, the bodies of the audience members collectively function as a single giant joystick. The audience can hold their arms upwards and wave them from side to side, for example, to indicate that they want to turn left or right, or to look forward and/or move forward. Other motions using body parts and/or other objects are also possible. The 2D/3D navigation system accommodates the fact that different audience members may gesture in different directions or to different degrees at any given moment.

In some embodiments, the viewing area is divided into multiple control zones which are analyzed separately, with each control zone passing on a separate Motion Index to the simulation engine. The different control zones might compete against each other or play separately in the same scenario, analogous to a multi-player video game. The view screen may be split into separate sections for each control zone group.

The invention includes free-form group navigation methods, where the audience moves from point to point in a scenario by: a) rotation to look at a virtual landscape around them, b) stopping rotation and continuing to “look” in a desired direction of travel and/or at a target for at least a set period of time, and c) the virtual scenario moving the audience in that direction or to the target. The forward motion could be continued until a point of interest is reached, for a set physical distance, and/or until the audience “looks” in a different direction. Alternatively, the audience may move forward (i.e. in the direction they are looking) continuously, gesturing to the left and right to rotate and steer in those respective directions.

In other embodiments, “point and click” navigation allows movement only between preset points in the 2D or 3D virtual world. Point and click navigation is combined with free-form navigation in some embodiments.

Point and click navigation and free-form are both well suited for 2D and 3D games, or for allowing the audience to wander through re-creations of far away, imaginary, or long-gone places.

The invention also includes linear scenarios where the audience navigates along a virtual linear path. The virtual path may include nodes where the path branches, and where the audience can choose among multiple finite paths by rotating to look down the preferred path for a set time period to indicate a choice. Typically in these linear scenarios the audience can rotate to look in different directions, moving forward when looking forward, optionally moving backward when looking backward depending on the scenario, and not moving at all when looking to the sides. There may be a “force feedback” feature where the virtual character is biased or “pushed” to look and/or move in the “forward” direction along the virtual track, to move the scenario forward and/or to prevent the audience from getting lost. The linear track might take the audience on a virtual balloon ride, or through a virtual haunted house. A linear scenario with branching could create a 3D movie version of a “choose your own adventure” story where the audience is offered choices in the form of different paths at different points in the story.

The invention includes methods and arrangements for real-time capture of activity of a group of people. The method includes some or all of the following steps: providing an area sufficient to accommodate the group of people; providing a video camera; providing a microphone; providing a PC with video and sound card; and providing a display screen selected from the group consisting of LCD, plasma, LED computer monitor, projection screen, projector, and any display device that can display digital content. This can also include receiving motion information of a group of people via the camera; generating a motion index based on the motion information, the motion index indicating a direction the group moves based on a stimulus selected from the group comprising direct instruction by content or any motion that is triggered by content; capturing vocalization information from the group of people via a microphone; generating decibel-based data based on the vocalization information; generating log files, the log files being generated in real-time after each use of the system; generating a data set from the log files; indexing the data set, the data set being indexed by time of capture of motion data and capture of volume-based data and zones; parsing the indexed data set; and/or generating a graph, the graph mapping directly to frame-by-frame activity that is happening on screen as the audience sees it.

A Motion Index is a distillation of movements by multiple people into a single numerical value which is typically between −100 and 100. Faster movements or greater changes between successive frames will translate to a Motion Index having a greater absolute value (positive or negative). Slow movement, with less difference between successive frames, will give a Motion Index with a lower absolute value (positive or negative).

Typically a Motion Index of zero corresponds to no net motion, while positive and negative Motion Indexes indicate movement in opposite directions with respect to a particular axis of movement (e.g. left vs. right).

Adaptive difference masking is a noise elimination technique to improve Optical Flow detection. Parts of audience area images captured by the video camera (i.e. the “capture zone”) will be background areas, as opposed to depicting audience members. For example, empty seats, walls, the sky (in outdoors settings) are all background. Different images of these background areas may contain incidental differences—e.g. camera fuzz—which the system might wrongly interpret as audience motion. Adaptive difference masking discards small variations as presumably being noise and not audience gesturing. Contemplated methods for determining a Motion index of a group of people can also include some or all of the steps of:

providing a camera;

providing a computer having a data processing capability;

capturing a real-time image of a group of people, the image having a plurality of data elements;

applying a first filtering of the data elements of the real-time image;

applying an optical flow algorithm to the real-time image;

applying a second filtering of the data elements for the real-time image;

generating a temporary optical flow velocity histogram;

maintaining the temporary optical flow velocity diagram for a pre-set period; and

updating temporary optical flow diagram for each new real-time image and/or for each iteration of the Motion Index;

wherein, when the distances of the group of people (i.e. the audience) relative to the camera is heterogeneous (i.e. some people are closer to the camera than others), imbalances in data received are minimized by partitioning the captured real time image into partition zones by dividing larger partition zones into smaller partition zones, and calculating a separate Motion Index for each of them;

wherein the size and number of partition zones is calculated by recursive partitioning method;

wherein an Average Motion Index is determined, the Average Motion Index being an arithmetic average of the individual Motion Indexes for respective partition zones; wherein said arithmetic average is preferably calculated according to a formula selected from the group consisting of

$${M}^{t} = \frac{{Σ}_{i = 1}^{Rows} {Σ}_{j = 1}^{Cols} {M}_{ij}^{t}}{Rows Cols} , \\ {M}^{t} = \frac{{Σ}_{i = 1}^{Tot Partitions} {M}_{i}^{t}}{Tot Partitions} , and$$

$${M}^{t} = \frac{{Σ}_{l = 1}^{4} {M}_{i}^{t}}{4} .$$

The above methods, or other methods within the scope of this disclosure, can include some or all of the following steps and elements. The first filtering may comprise the step of applying masks to the real-time image. The first filtering comprises the step of removing sections of the image that are not to be processed by an optical flow algorithm. The second filtering may comprise applying a vector filter to the optical flow vectors. The second filtering can comprise removing vectors having a magnitude above or below a certain threshold.

Methods for determining a final motion index of a group of people can also comprise some or all of the following steps:

(a) providing a camera;

(b) providing a computer having data processing capability;

(c) capturing a real-time image of a group of people, the image having a plurality of data elements;

(d) applying a first filtering to the data elements of the real-time image;

(e) applying an optical flow algorithm to the real-time image;

(f) applying a second filtering to the real-time image;

(g) generating a temporary optical flow velocity histogram;

(h) keeping the temporary optical flow velocity diagram for a pre-set period temporary certain period of acquisition updated; and

(i) updating temporary optical flow diagram each iteration of the motion index; and

(j) determining a final value for the motion index.

Methods according to the invention may include the steps of: subjecting the audience to at least one element of content; capturing data concerning the response of the audience; delivering the data to a PC; processing the data by an algorithm stored on the PC; and analyzing the emotional content of the processed data.

It will be understood that the present invention includes any combination of the various features of novelty which characterize the invention and any combination of equivalent features. The embodiments which follow are presented for the purposes of illustration only and are not meant to limit the scope of the present invention. Thus, all the features of the embodiments which follow are interchangeable so that each element in each embodiment may be applied to all of the embodiments taught herein.

Another preferred method of presenting interactive video content to an audience includes at least the following steps:

providing an audience area for accommodating a plurality of audience members, and a view screen which is visible from the audience area;

providing a video camera which is capable of recording digital video, the video camera being pointed at the audience area, the video camera being functionally connected to a computer for passing video data to the computer;

wherein the computer comprises a memory and a processor, and wherein the computer is functionally connected to the view screen for displaying 2D or 3D video content on the view screen;

the method further comprising:

displaying 2D or 3D video content on the view screen, the video content on the view screen being at least partially controlled by the computer, the video content comprising simulation of movement through a 2D or 3D scenario from a first person perspective, said first person perspective being a camera view;

the video camera capturing digital video of the audience area while the video content is presented on the view screen and while a plurality of audience members are in the audience area, the captured digital video comprising a chronological series of audience images, and the video camera passing the chronological series of audience images on to the computer;

determining Optical Flow vectors for a plurality of different locations in each of the audience images, wherein Optical Flow vectors are determined by a process comprising comparing a location in an audience image with the same location in a chronologically earlier audience image to determine motion at that location;

determining Motion Index values for a chronological series of audiences images, with Motion Index values being determined by a process comprising comparing a current Optical Flow vector with one or more previous Optical Flow vector;

controlling rotation of the camera view using successive Motion Index values;

wherein the 2D or 3D content displayed on the view screen comprises at least one interaction item;

the video camera capturing digital video of lateral gestures by a plurality of audience members in the audience area, the computer determining a plurality of Optical Flow vectors and a plurality of Motion Index values based on said digital video of lateral gestures, and rotating the camera view to one side in response to said Motion Index values;

the interaction item moving from a side of the camera view to a center area of the camera view during said camera rotation, with the camera rotation stopping at a point where the interaction item is in the center area of the camera view in response to a plurality of audience members ending said lateral gesturing; and

after the camera rotation stops, and in response to the interaction item remaining substantially in the center of the camera view for a threshold period of time, displaying a 3D animation of the camera view moving toward the interaction item on the view screen.

In preferred embodiments the audience area comprises a plurality of seats in at least one of a theater, a cinema, a stadium, a grandstand, a set of bleachers, a music venue, and an arena.

In preferred embodiments the lateral gestures by a plurality of audience members comprise lateral arm movements.

The Motion Index values for the audience images are preferably values from −100 to 100, wherein negative Motion Index values cause the camera view to rotate in a first direction, wherein positive Motion Index values cause the camera view to rotate in a second direction which is different from the first direction; and wherein Motion Index values of zero do not cause the camera view to rotate.

The interactions items can be at least one of a character, a living creature, an object, a vehicle, an intersection, a building, or essentially any object or living thing which is part of a scenario.

The simulation of movement through a 3D scenario from a first person perspective can include simulation of movement through at least one of, without limitation: a city, a town, a maze, a building, an outdoor landscape, a racecourse, an underwater landscape, outer space, or a fictional universe.

In some embodiments the audience area and corresponding audience images are divided into multiple control zones. The Optical Flow vectors and Motion Index values are then determined separately for each control zone, with said Optical Flow vectors and Motion Index values being determined at least partially based on gestures by different audience members in different respective control zones. Different camera views are displayed on one or more view screens, each corresponding to a control zone. Motion Index values from different control zones are used to control different respective camera views.

In preferred embodiments the audience images are divided into a plurality of partition zones. Optical Flow vectors are separately determined for each partition zone, and Motion Index values are separately calculated for each partition zone. Preferably Average Motion Index values are also calculated for a plurality of time points, the Average Motion Index values each being an average of the Motion Index values for a plurality of individual partition zones. Rotation of the camera view is controlled using the Average Motion Index as an input

Often the audience area comprises areas which are closer to the video camera and areas which are further away from the video camera. In some embodiments the audience images are divided into a plurality of partition zones, with some partition zones being larger than other partition zones. Preferably a first partition zone corresponding to a first part of the audience area is larger than a second partition zone corresponding a second part of the audience area, and the first part of the audience area is closer to the video camera than the second part of the audience area. Preferably Optical Flow vectors are separately determined for each partition zone. Also preferably, Motion Index values are separately calculated for each partition zone. Average Motion Index values are calculated for each of a plurality of time points, the Average Motion Index values each being an average of the Motion Index values for a plurality of individual partition zones at a particular time point. Rotation of the camera view is achieved using the Average Motion Index values as an input. This system may be referred to as a Crowd Participation Index.

In some embodiments using partition zones, the plurality of partition zones are determined by a dynamic partitioning process, the dynamic partitioning process comprising:

A. providing at least a first partition zone;

B. dividing the first partition zone into a plurality of smaller subzones;

C. determining one or more comparison values for each of the subzones, wherein the comparison values are one of Optical Flow vectors and Motion Index values;

D. comparing the comparison values of the subzones;

E. if at least one of the subzones has a comparison value which differs from the comparison value of one or more of the other subzones at the same time point by at least a threshold amount, retaining all of the subzones as independent partition zones; and

F. if none of the subzones have a comparison value which differs from the comparison values of the other subzones at the same time point by at least the threshold amount, re-merging the subzones into the first partition zone;

wherein, during the presenting of 3D video content to a plural audience:

Optical Flow vectors are separately determined for each partition zone;

Motion Index values are separately calculated for each partition zone;

Average Motion Index values are calculated for a plurality of time points, the Average Motion Index values each being an average of the Motion Index values for a plurality of individual partition zones at a particular time point; and

rotation of the camera view is controlled using the Average Motion Index values as inputs. Preferred embodiments also apply a force feedback to the camera view which rotates the camera view towards the interaction item independent of the Motion Index values and independent of gestures by audience members.

Another preferred system and method includes providing an audience area for accommodating a plurality of audience members, and a view screen which is visible from the audience area. The system includes a video camera which is capable of recording digital video, the video camera being pointed at the audience area, the video camera being functionally connected to a computer for passing video data to the computer. A computer comprises a memory and a processor, and wherein the computer is functionally connected to the view screen for displaying 3D video content on the view screen.

This preferred system also includes displaying 3D video content on the view screen, the video content on the view screen being at least partially controlled by the computer, the video content comprising simulation of movement through a 3D scenario along a linear path from a first person perspective, said first person perspective being a camera view. The video camera captures digital video of the audience area while the video content is presented on the view screen and while a plurality of audience members are in the audience area, the captured digital video comprising a chronological series of audience images, and the video camera passing the chronological series of audience images on to the computer.

Optical Flow vectors are determined for a plurality of different locations in each of the audience images, wherein Optical Flow vectors are determined by a process including comparing a location in an audience image with the same location in a chronologically earlier audience image to determine motion at that location.

Motion Index values are determined for a chronological series of audience images, with Motion Index values being determined by a process including comparing a current Optical Flow vector with one or more previous Optical Flow vectors.

Rotation of the camera view is controlled using successive Motion Index values as input. At the same time, the video camera captures digital video of lateral gestures by a plurality of audience members in the audience area, the computer determining a plurality of Optical Flow vectors and a plurality of Motion Index values based on the digital video of lateral gestures, and rotating the camera view to one side in response to said Motion Index values. Video content displayed on the view screen includes simulation of movement through a 3D scenario along a linear path having a forward direction and a backwards direction. When the camera view is oriented in the forward direction, the camera view displays movement through the 3D scenario in the forward direction along the path at a first speed. When the camera view is oriented 90° away from the forward direction, the camera view displays one of (i) no movement along the path, and (ii) movement along the path in the forward direction at a speed which is less than the first speed. The video content displayed on the view screen comprises simulation of movement through a 3D scenario along a linear path having a forward direction and a backwards direction. When the camera view is oriented in the forward direction, the camera view displays movement through the 3D scenario in the forward direction along the path. When the camera view is oriented 90° away from the forward direction, the camera view displays no movement along the path. When the camera view is oriented in the backwards direction, the camera view displays movement through the 3D scenario in the backwards direction along the path.

In further preferred embodiments the video content displayed on the view screen comprises simulation of movement through a 3D scenario along a linear path having a forward direction and a backwards direction. When the camera view is oriented in the forward direction, the camera view displays movement through the 3D scenario in the forward direction along the path at a first speed. When the camera view is oriented at a diagonal angle intermediate between the forward direction and 90 ° away from the forward direction, the camera view displays movement along the path in the forward direction at a speed which is less than the first speed.

In other embodiments the direction and velocity of movement along the linear path (V_{Camera}) is determined by the angle of the camera view with respect to the forward direction (α_{camera}), wherein the camera view facing directly in the forward direction is an angle of 0° and the camera view facing in the backwards direction is an angle of 180°. V_{Camera} is determined by a method comprising the relationship:

$$VCamera = ( 1 - \frac{α Camera}{90} ) ,$$

with positive V_{Camera} values corresponding to motion in the forward direction and negative V_{Camera} values corresponding to motion in the backward direction.

In some embodiments the 3D video content displayed on the view screen comprises at least one interaction item. The video camera captures digital video of lateral gestures and/or up and down gestures by a plurality of audience members in the audience area, the computer determining a plurality of Optical Flow vectors and a plurality of Motion Index values based on said digital video of lateral gestures, and rotating the camera view to one side in response to said Motion Index values. The camera rotation may then stop at a point where the interaction item is in the center area of the camera view in response to a plurality of audience members ending said lateral gesturing. After the camera rotation stops, and in response to the interaction item remaining substantially in the center of the camera view for a threshold period of time, a 3D animation of the camera view zooming in towards the interaction item on the view screen is displayed.

In some embodiments the linear path further comprises at least one intersection, the intersection being a branched location in the linear path where at least three different travel directions are available. When the 3D scenario reaches an intersection, the audience selects a travel direction by a plurality of audience members gesturing in a rotation direction, the camera view rotating in the rotation direction until the camera view is facing in a selected linear path, at which time a plurality of audience members stop gesturing which in turn causes the camera view rotation to stop. After the camera rotation stops, and in response to the camera view facing the selected linear path for at least a threshold period of time, a 3D animation of the camera view moving down the selected linear path is displayed on the view screen. The same steps can be utilized to navigate a 2D linear path, which can have branches.

The 3D scenario displayed on the view screen can include a virtual tour of a real or fictional physical location, with said linear path traversing the physical location.

A more general preferred system and method includes providing an audience area for accommodating a plurality of human audience members, and a view screen which is visible from the audience area. A video camera is provided which is capable of recording digital video, the video camera being pointed at the audience area, the video camera being functionally connected to a computer for passing video data to the computer. The computer is functionally connected to the view screen for displaying video content on the view screen.

The method then typically includes displaying either 2D or 3D video content on the view screen, with the video content comprising simulation of movement through a video scenario. A field of vision being displayed on the view screen is called a camera view. While video content is presented on the view screen, the video camera captures digital video of the audience area comprising a plurality of audience images, which audience images depict gestures by a plurality of audience members in the audience area. The method further includes comparing a current audience image to one or more previous audience images, and rotating the camera view in response to said gestures by a plurality of audience members. In some instances the video content displayed on the view screen comprises at least one interaction item. A plurality of audience members may gesture in a first direction, and the camera view rotates in said first direction in response to said gestures. Preferably said camera view rotation continues until the interaction item is in a center area of the camera view, wherein a plurality of audience members who were gesturing in the first direction stop gesturing and, in response to the stopping of said gesturing, camera rotation stops. After the camera rotation stops, and in response to the interaction item being substantially in the center of the camera view, an animation of the camera view moving toward the interaction item is displayed on the view screen.

In typical embodiments the audience area comprises areas which are closer to the video camera and areas which are further away from the video camera. When the computer is processing the audience images, the audience images are divided into a plurality of partition zones, with some partition zones being larger than other partition zones. In some embodiments a first partition zone corresponding to a first part of the audience area is larger than a second partition zone corresponding a second part of the audience area, and wherein the first part of the audience area is closer to the video camera than the second part of the audience area. Preferably Optical Flow vectors are separately determined for each partition zone, and Motion Index values are separately calculated for each partition zone. Preferably Average Motion Index values are calculated for each of a plurality of time points, the Average Motion Index values each being an average of the Motion Index values for a plurality of individual partition zones. Preferably rotation of the camera view is then controlled using the Average Motion Index values as an input. Motion Index control is preferable to control based on, for example, raw Optical Flow vectors including because it is scalable (for example from −100 to 100) regardless of the actual physical distance audience members move, and because it gauges movement based on local motion history and ranges so that audience members close to and far from the video camera may be give similar weight in controlling each scenario.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a representation of a computer game wherein the motion of a human audience's raised arms controls the motion of a car across two contiguous lanes using lateral body motions;

FIG. 2 is a representation of a computer game with left and right motion;

FIG. 3 is a flowchart of steps for computing a Motion Index, according to certain embodiments of this disclosure;

FIG. 4 is a graph of Optical Flow peaks over time for a audience playing a catch and dodge game;

FIG. 5 is a bar chart histogram of Optical Flow values for a human playing a game at two different distances from the camera;

FIG. 6 is an illustration of the different length of Optical Flow vectors for a camera when placed in the center of a theatre, and placed in a corner, relative to the space of image acquisition;

FIG. 7 is a bar chart histogram of Optical Flow values when a camera is placed in a corner relative to the space of image acquisition;

FIG. 8 is a graph of the statistical rank for the Optical Flow values in the histogram of FIG. 7 (0 being the lowest and 1.0 being the greatest) when a camera is placed in a corner, and two Motion Indexes (−50 and 80) determined by comparing current Optical Flow vectors with the graphed histogram values;

FIG. 9 is a flowchart of an accuracy-improvement algorithm for a Boolean Index, according to certain embodiments;

FIG. 10 is a flowchart for determining a Crowd Participation Index, according to certain embodiments;

FIG. 11 is a flowchart showing a preferred relationship among hardware elements in a preferred venue;

FIG. 12a-12c is a flow chart showing local deployment of the system using a USB drive;

FIG. 13a-13d is a flow chart showing deployment of the system over a network;

FIG. 14 is an illustration of uniform size partition zones as applied to audience members near the camera and further from the camera;

FIG. 15 of chart of uniform size partition zones in a uniform grid;

FIG. 16 illustrates an alternative uniform partition zone system and the relative weight given to different audience members;

FIG. 17 illustrates a non-uniform partitioning, with partition zones of different sizes, to minimize player size and location effects;

FIG. 18 is a partitioning system using partition zones subdivided into quadrants;

FIG. 19 illustrates an exemplary partitioning tree to for a maximum of 3 levels used to keep a history of velocities to be used in motion index computation;

FIG. 20 is an exemplary illustration of a dynamic partitioning sequence;

FIG. 21 is an interface for applying aisle masks to an image of an audience area in a theatre;

FIG. 22 depicts an audience interacting with a 3D scenario including an interaction item;

FIG. 23 is a flowchart illustrating how audience images are captured, processed in an AEIS server, and passed as data to a simulation engine for controlling a scenario;

FIG. 24 is a flowchart showing how AEIS server data is processed and used to control camera view and scenario navigation;

FIG. 25 is a flowchart of navigation through a linear path 3D scenario;

FIG. 26 is flowchart of navigation through a free-form or point-and-click navigation 3D scenario;

FIG. 27 shows a theatre seating section divided into four control zones;

FIG. 28 shows a sample log file, having only one entry, for a single control zone arrangement;

FIG. 29 shows sample data log entries from a multiple control zone arrangement having four control zones and a 2D motion index;

FIG. 30 is a flow diagram of .NET socket communication between AEIS and the Unity game;

FIG. 31 is exemplary AEIS motion data for a controlling a game as received by a game engine;

FIG. 32 is an example of an XML format motion data report;

FIG. 33 shows a three person audience interacting with a linear navigation scenario;

FIG. 34 shows a three person audience interacting with a free-form navigation scenario;

FIG. 35 shows an audience hovering on an interactive object and, in three sequential screens, moving towards the interactive object;

FIG. 36 is an interface for controlling microphone volume and minimum trigger level;

FIG. 37 in an interface for calibrating motion capture;

FIG. 38 is the same interface as shown in FIG. 37, with the audience member having moved to one side; and

FIG. 39 is a graph of Velocity Sub motion readings of an audience over time.

### DETAILED DESCRIPTION OF THE PREFERRED EMBODIMENTS

Introduction to Group Content Navigation

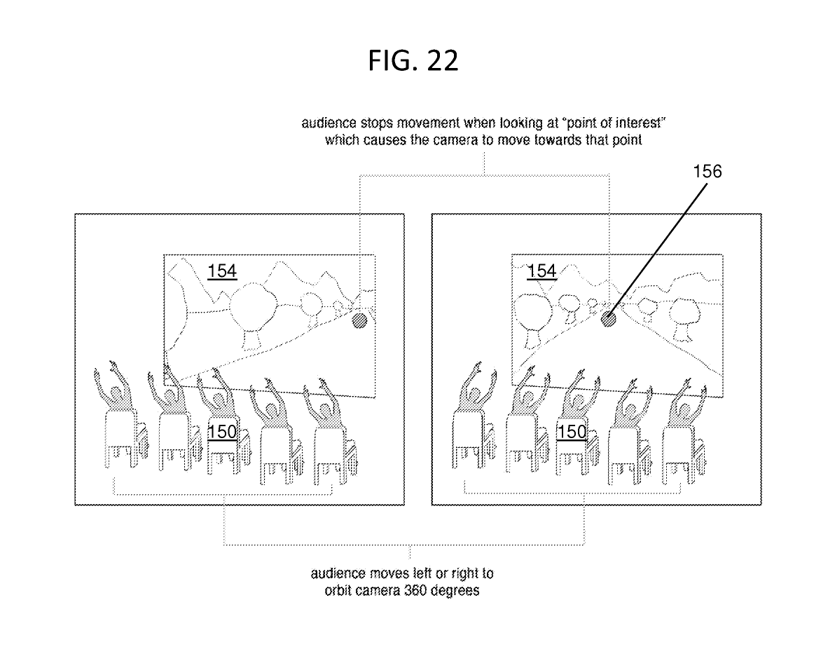

This invention provides new systems and methods that allow groups of people to collectively navigate and interact with 2D and 3D content (i.e. “scenarios”) in real-time, using a system including group motion capture. As shown in FIGS. 22 and 33-35, audiences 150 in cinemas, theatres, stadiums, or other venues can collectively control 2D and 3D content on a large view screen 154 by moving their arms and bodies to the left and right, by standing still, and in some embodiments also by moving up and down. The view screen reflects the audience movements, typically from a first-person perspective, as if through the eyes of a single individual or out the front window of a shared vehicle or spaceship. When the audience gestures to the left, the camera view on the large screen rotates left. When the audience gestures to the right, the view on the screen rotates towards the right. When the audience is generally still, there is typically no rotation, and the scenario walks or drives forward (depending on the scenario) and/or approaches and interacts with an item of interest 156 which is straight ahead.

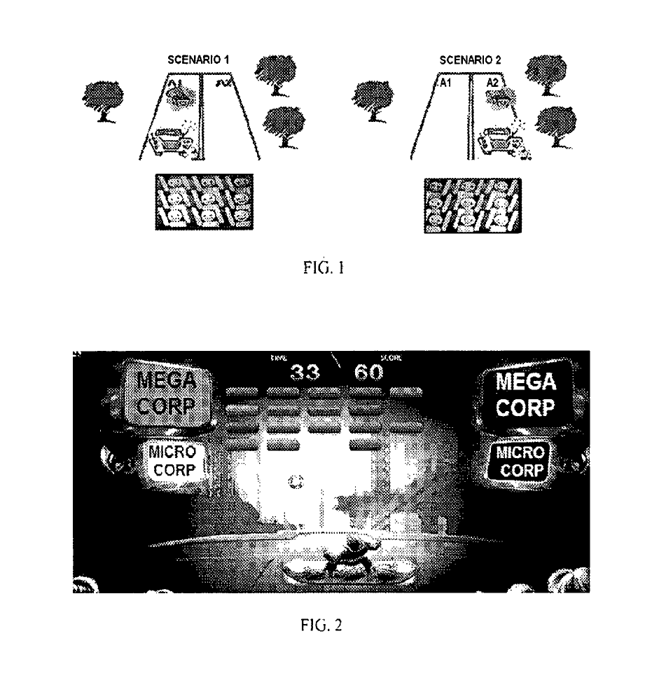

“3D” scenarios refers to scenarios where the camera view shows motion in three dimensions, typically but not necessarily from a first person perspective. See, for example, FIGS. 22 and 33-35. The audience may or may not actually be able to actually maneuver is three dimensions in a 3D scenario. For example, a 3D scenario simulating a walk through a field might not include any ability to move upwards (into the sky) or downwards (into the ground). “2D” scenarios refers to scenarios where the scenario is shown as basically flat, and motion is only possible in either one or two dimensions. See, for example, the lane changing game in FIG. 1 and the brick-breaker game in FIG. 2. 2D scenarios could also include navigating a character or avatar, viewed from above, in two dimensions.

Elsewhere in this disclosure, there are exemplary embodiments of specific algorithms to implement an interactive game where the bodies of a plural audience are used together as a unified control means. In alternative embodiments, audience members use electronic devices and/or sounds, in addition to body movements, to interact with a scenario.

Two broad types of 2D and 3D navigation scenarios contemplated include, without limitation:

A) Free Form and Point-and-Click Navigation: Navigating in (at least) two dimensions on a horizontal plane or in a maze, in some embodiments through panoramic 360 ° scenarios. Free form navigation means rotating and walking in any direction for any distance, within the boundaries of the scenario. Point-and-Click means movement between a set of defined points. And,

B) Linear Navigation: Maneuvering along a one dimensional string-like path within a 2D or 3D scenario, combined with an ability to look or point in different directions and move forwards and backwards along the path. Some embodiments traverse panoramic 360° scenarios. The path may include choices and branches, and the path itself may traverse two or three dimensions, but movement is generally forward, back, and stop along a fixed path.

Both general types of scenario A and B preferably include the ability to stop within a scenario to interact with an area, object, or person of interest 156, typically where indicated by a graphical, written or verbal instruction.

Both types of scenario may include the ability to look up and down as well as to rotate left and right. This is implemented by having two different axes of motion detection (e.g. Hybrid scenarios where the audience moves between a finite set of preset points in an open area, or where the audience can move freely along a web of linear paths having many intersections, are also contemplated.

One aspect of the invention includes using group motion detection and interpretation to control and interact with 3D immersive content. Historically, 3D immersive live video or game simulation content has been a single user experience, typically using 3D headset or similar user interface. The new group navigation technology is applicable to provide a virtual reality experience for a group of people. In preferred embodiments the audience is shown images not only in front of them, but also in wrap-around fashion on their sides, and even above and/or behind them. The new group navigation technology can be applied to create a first person virtual reality experience in a movie theatre setting.

Members of a crowd lean left, lean right, or stay relatively still to navigate through panoramic 360° scenarios. This scenarios can include video, 3D computer graphic scenes, 2D map-like worlds, or still photography. In addition to moving left and right or rotating left and right, the technology allows groups a greater level of control by adding a third “centered”, or “stand still” option. This feature is not simply a matter of standing still, although it can be used as such. The third “centered” audience state allows the audience to express interest in places and items of interest in the scenario by “hovering” on them.

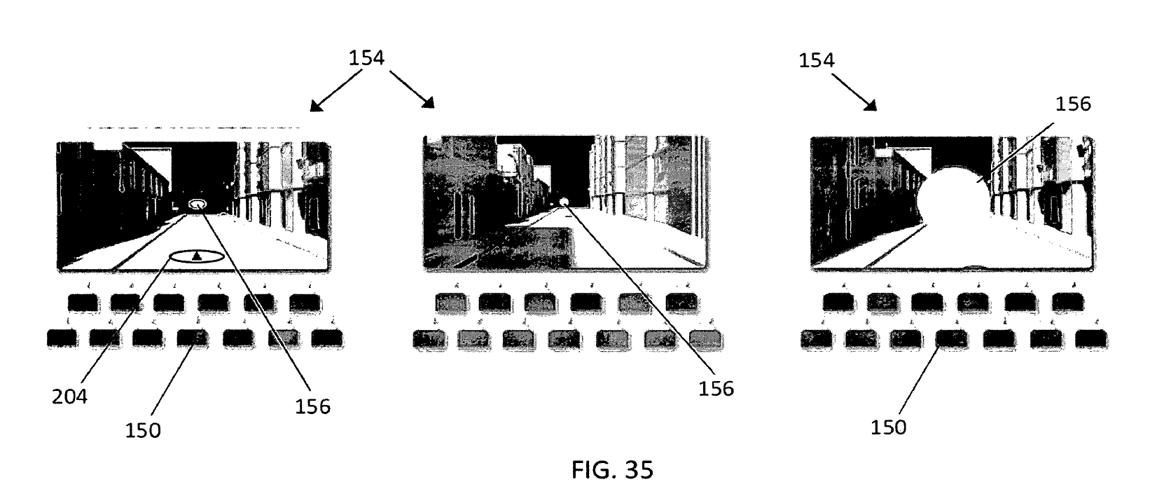

In some embodiments this state—where the audience collectively “votes” to continue looking at something—is used as a “select” or “interact” function. Centering on a place or object is used as a “move forward” “go to that” or “interact with that” instruction within a 3D environment. See FIG. 35.

In some embodiments the “centered” state is used in combination with voice commands. For example, by stopping and being centered while an object is in view, the audience could be presented with an option to interact with a content object or not. For example, in a first person 3D game, the audience might steer left and right until stopping when a game character is in the center of their field of view. In a 2D game the audience might rotate an avatar viewed from above until it is pointing at a game character. A preferred system interprets this stopping as a command to move towards that character and/or to interact with the character. The character might deliver a message to the audience, and offer the audience an option to accept or reject, as determined by collective voice commands. The audience might also collectively choose to turn away from the person after the message and/or offer, which could be interpreted as declining the offer and/or a command to move away from the character and towards other locations. In preferred embodiments, when the audience faces or “centers” in a given direction, it results in forward motion to a point of interest, for a set distance, until an obstacle is encountered, until the audience looks in a different direction, and/or until the audience takes some other action.

Optionally, other input means, such as buttons, remote controls, smart phones, pedals, joysticks, or floor sensors, can be used in combination with the gesture-drive audience motion systems for interacting with and navigating within 2D and 3D scenarios.

In a preferred embodiment, a simulation engine 131 receives normalized input data from a Motion Track Server 121 (e.g. the AEIS server 121) which detects the movements of the audience on the horizontal axis. A video camera 300 captures images of the audience which are interpreted by the Motion Track Server 121. In a preferred embodiment the input data comprises Motion Index values, and the navigation algorithm is part of a simulation engine 131 running a 3D scenario. The input data allows the audience to collectively control a “virtual camera”, turning it left and right or holding it still. The audience's viewpoint is called a “camera view” 152. In a preferred embodiment discussed below, the gestures of all the audience members are used to calculate a Motion Index having a value of between −100 and 100, with the Motion Index being constantly updated as the scenario progresses and the audience moves or stops moving. In a preferred embodiment discussed below, the system simulates the viewpoint of a virtual tourist (the “camera view”) moving forward backwards, and rotating to look left and right. Preferably scenarios contain information to provide a view in any direction from any location in the scenario, whether a 360° video or a virtual world. Which parts of the view are shown to the viewers, and from what perspective (front, sides etc.) will vary based on where the users are located in the scenario and how they collectively decide to turn the camera view 152. The virtual camera is collectively controlled by the audience. Typically leaning or gesturing to the right rotates the camera clockwise, while leaning or gesturing left rotates the camera counter clockwise. A drag factor can be applied to the rotating camera to prevent infinite, violent, or overly fast swings in motion. This increases the sense of control of the users.

A force feedback function (see below) can be applied to “push” the camera view toward items of interest or interesting locations. This can be useful for moving a story forward and preventing the audience from getting frustrated or lost, or spending long periods moving around with nothing happening.

In one embodiment the system allows a movie audience to select among movie trailers or other advertisements, such as by centering on a preferred item or choosing a left option vs. a right option.

The system can be used to allow an audience to interact with advertising messages, such as by voting for left or right options on a screen, or navigating in a 3D world which includes advertising content. An audience could be invited to wave their arms left and right in unison to control a game onscreen as part of a short advertising piece before or during a larger event. For example allowing audiences to control a cartoon character as he slides down a 3D waterslide as part of a promotion for a theme park or cruise line. A 3D car driving game could be used to promote a car. Pre-packaged advertising game modules could be provided which are then customized to various advertisers.

The system can be used to let an audience vote between options in a movie or other content at set points, analogous to a “choose your own adventure” book presented as a movie. The audience could be allowed select a preferred ending for a feature film.

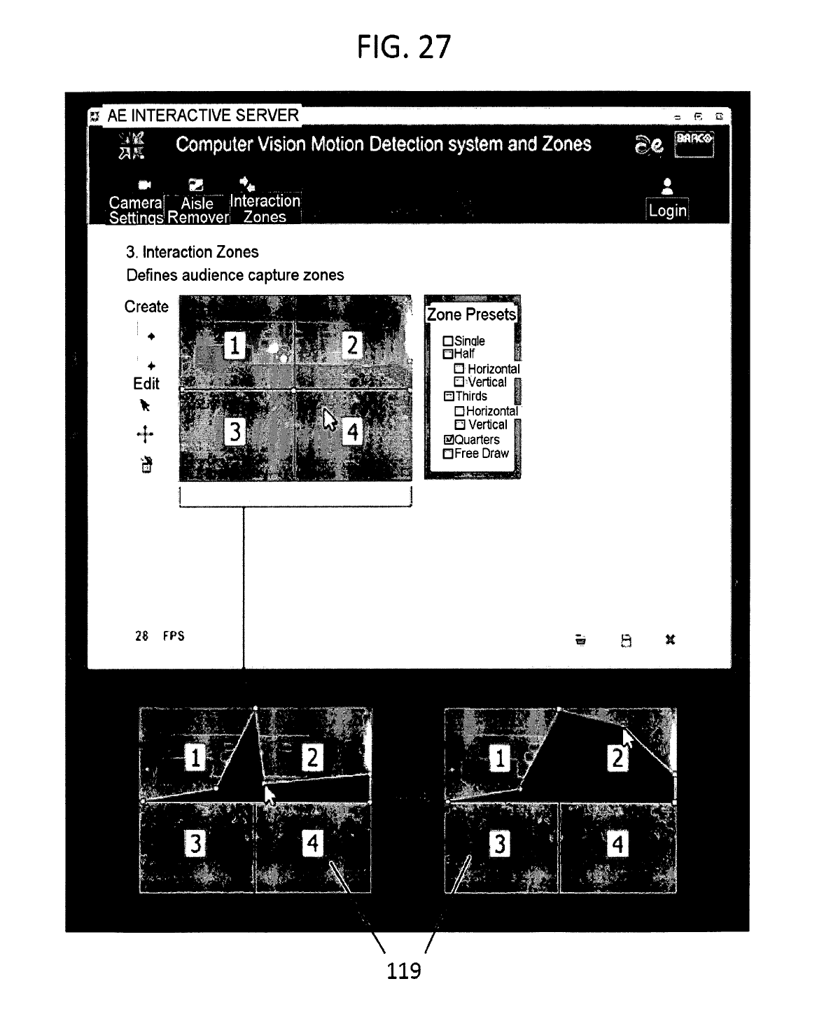

In alternative embodiments, the audience is divided into two or more motion capture zones (see FIG. 27 element 119), which are treated separately for motion capture and scenario purposes. This may involve using multiple cameras or dividing a single field of view into separate portions. Typically separate Motion Indexes will be determined for each group. For example, each side of a theatre audience could be designated as a “team” which play a game either alternately or at the same time. The arrangement could be analogous to a video game console where two users each have their own joystick or controller. Each team might have its own video screen, or a single screen might be divided into separate parts for each team.

In some preferred embodiments, the audience is not using any devices or physical control objects such as buttons, touchscreens or joysticks, and are interacting with audiovisual content exclusively using physical gestures in open space. In other embodiments, gesture control and device control may be combined.

Adding a Second Control Dimension—2D Motion Index

To add up and down motion control to a simple left/right system as described elsewhere, the same calculations are performed on the same images, but with the motion being measured in the second dimension. Optical Flow is determined in two different axes per frame, with each set of Optical Flow data added to a histogram specific to that axis. Two different Motion Indexes are calculated per frame, one for each axis. A 2D Motion Index can then be a two-dimensional vector with values ranging from −100 to 100. For example, Optical Flow in both up/down and left/right axes can be determined by computing the same series of images, with those values then used to compute both left/right and up/down Motion Indexes simultaneously. Data other than Motion Index can also be gathered, processed, and reported in both the vertical and horizontal axes simultaneously.

FIG. 29 shows sample data from a multi-zone arrangement having four zones and a 2D motion index. Note that both up/down and left/right motions are logged.

Linear Navigation

In some embodiments the audience moves along a one dimensional, string-like path 200, controlling movement only forwards and (in some embodiments) backwards along that path. Such a path may have branches and nodes, so that the audience is offered options for movement along multiple paths, but only at designated nodes. This could be combined with an ability to zoom in on object of interest for a closer look, without actually leaving the virtual path. The audience can control which way they look by collectively turning left or right, and then stopping (“centering”) when they are looking in the desired direction. The audience could choose to move forward along the path by looking forward, or to move backward by looking backward. Some embodiments include a default forward motion along the path to advance the scenario, and in case the audience input is mixed or inconclusive. The scenario might move forward at a slow default speed if the audience is not zooming, examining, or interacting with anything, or if time limits are exceeded. This implementation is useful to create virtual fly-over balloon tours or other virtual place tours, or to create a virtual walk through a haunted house. Guided movement through a virtual 3D space, in combination with nodes for interaction and/or choosing among multiple paths, can be used to create a virtual, immersive “choose your own adventure” story with 3D action.

Related embodiments guide an audience through 360° video scenarios where the motion of the real-world cameras which filmed the 360° content was close to constant, such as aerial footage of a landmark taken by several cameras which each point in a different direction. The audience may be taken through a virtual aerial tour scenario at a fixed rate which simulates the speed of the actual aerial filming, but where the audience can look in different directions by rotating the camera view. Alternatively, the virtual tour scenario can display the footage at speeds other than the original speed, with users controlling both the video playback viewpoint and movement speed by looking forward or sideways etc.

Thus, in one preferred scenario, the camera translates along a predefined path, at a constant speed. The users can collectively rotate the camera view left and right a full 360°, and even point it backwards. The effect is as though the user/crowd are really at the location which was videoed, or in a 3D graphic game environment. The group can collectively point the shared virtual camera in any direction. Alternative embodiments include multiple view screens surrounding the audience, and individual users can also look around in any “real world” direction in the viewing space to see things on their sides, or even above, below or behind them, depending on the physical setup of the viewing space. For example, a front screen of a movie theatre can display the direction the shared virtual camera is facing, while left and right screens of the theater simultaneously show the left and right views from that virtual location. Each individual person in that theatre can thus always see different things on screens in front of them and also on two sides, more or fewer sides depending on the theatre or venue. These features combine to make the experience more like you are really there.

Various content is usable with a linear or predefined path scenario. Flowing 3D spatial video (e.g. filmed via a 4+ camera flying drone) of an exotic landmark such as Petra, Jordan (see FIG. 33), the Grand Canyon, a cave, a theme park, or a mountain range are examples. Using physical gestures as elaborated elsewhere, the audience can follow one or more paths around the replica landmark, look in different directions, zoom in on interaction items 156 for a better view, etc. The effect is like a virtual airplane or balloon tour. The system can provide simulations of skiing down famous mountains, skydiving, racing around a track, touring famous cathedrals, or exploring a replica of an ancient city. FIG. 33 is an exemplary screen capture of a virtual tour of Petra, Jordan shown on a movie screen 154, with a small three person audience 150 schematically added at the bottom.

The path 200 is visible as a dashed line in this example, although it may or may not be visible in other embodiments. The audience 150 are leaning left, which causes the camera view to rotate to the left. In some embodiments this will also cause the virtual camera to travel along the path 200 in the left direction as the camera rotates in that direction. By focusing or “hovering” on the point of interest 156 the audience can, in this embodiment, get a zoomed-in view of that part of the monument.

The translation velocity of the camera along a path can also be controlled by the audience in some embodiments. In a preferred embodiment, forward velocity decreases as the camera view's rotation away from the forward path direction increases. For example looking forward (0°) is full speed, looking sideways (90°) stops the motion, and looking backward (180°) reverses the motion, moving backwards. Looking forward and to the side (e.g. 45°) could result in slow forward motion, and backwards to the side (e.g. 135°) in slow backward motion. In some embodiments moving backwards is limited or prohibited to keep the scenario on track. In alternative embodiments the velocity is held constant, or has a variable rate which is not controlled by the audience.

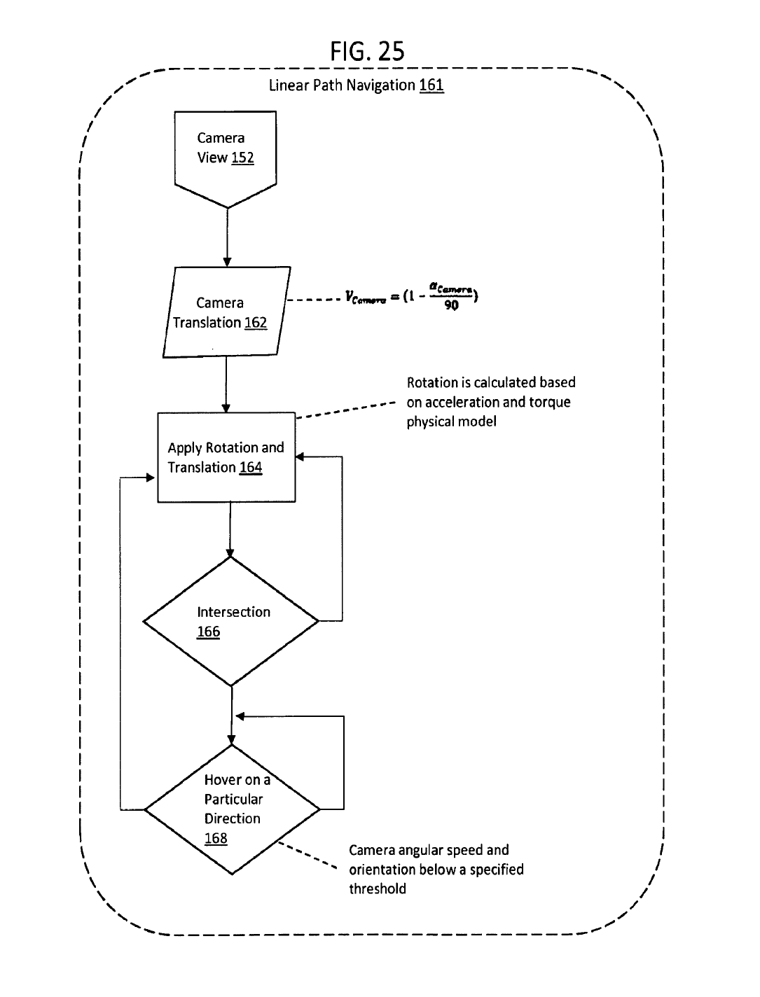

See below for a preferred implementation of linear navigation as outlined in FIG. 25.

2D linear scenarios are also within the scope of the invention. For example, a character or icon viewed from above, rotated left and right by audience gestures and able to navigate along a linear path having branches

Force Feedback

A “force feedback” system algorithm can be also added to provide a low but constant “force” turning the camera in the forward direction and/or moving the audience along the path in the forward direction. Force Feedback is particularly applicable to linear navigation scenarios.

Force feedback may be applied at all times absent alternative instructions from the audience, simply providing default forward direction and motion. Alternatively or in addition the force feedback may only be added after a set amount to time in a given location. The force feedback can be used to keep a scenario from taking overly long to run, and/or to prevent an audience from getting bogged down in a location if they cannot agree on a course of action or are otherwise stuck.

The strength of the force feedback could be calculated according to the angle of the virtual camera with respect to the forward motion direction. The force feedback can be attenuated in linear navigation scenarios when reaching an intersection (e.g. crossroad or designated path branching point), to let the user easily choose his destination/next action.

Force feedback can also be used with free form navigation and point-and-click scenarios.

Free-Form Navigation

In other embodiments, the audience can move through virtual 3D space freely for more open-ended experiences. For example, walking at will (e.g. by turning left and right and looking/centering where they want to go) through a maze, dungeon, or real or virtual city. Navigation in a free-form scenario will often be confined to two dimensional travel on a “map” of a virtual place in the scenario, although the camera view may show a 3D space. For example, a scenario might allow exploration anywhere in a virtual town, but prevent travel beyond the edge of the town. Prompts or hints could be provided to keep the audience moving through a location, story, or scenario, such as arrows or directions from virtual characters. Interactive places and objects can be included as well.

Force feedback can also be used with free form navigation and point-and-click scenarios. Force feedback can be used to push or turn the camera view towards items and locations of interest to help the audience navigate and prevent frustration. Force feedback can also be used to point the camera view directly at items of interest when the camera view is pointed near, but not directly at, the item. This helps the audience to hover on items to interact with them or to move between points of interest.

An algorithm detects when the camera view is sufficiently near or pointing directly at an interactive object or location 156, and may focus and/or zoom the camera toward it. Interactive locations and objects can then trigger actions such a new content display or invitations to interaction. View-from-above maps of a virtual space may be provided. Sliding “maps” can be displayed at the bottom of the screen to help the users orientate in the environment and see where objects are.

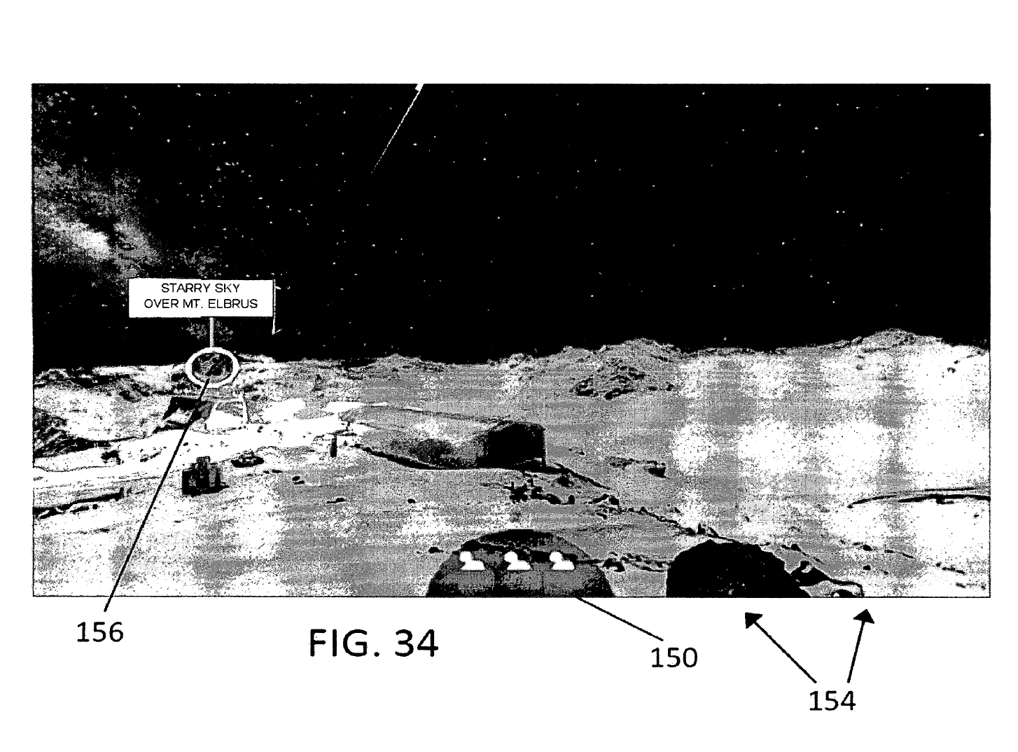

FIG. 34 is a screen shot from a free-form navigation scenario which simulates exploring near Mt. Elbrus in the Caucasus Mountains. A bright circle indicates a location of particular interest 156. The audience 150 can travel to that point of interest 156 by swaying to the left as shown until the camera view points at the object or interactive point 156, stopping rotation by not gesturing, waiting for a moment, at which point the camera will move in that direction. FIG. 35 shows a similar process in three steps. On the left the audience looks directly at the interaction item 156. In this example, the direction the camera is facing is indicated by an arrow in a pointer avatar 204. Note that the audience 150 is not leaning in either direction, and so are not rotating the camera, and are therefore sitting still facing the object 156. In the middle frame the camera has moved closer to the object 156, and in the right frame has arrived at the object. At this point, an interaction or other scenario event would typically begin.

Free form, free-motion scenarios have different advantages than linear scenarios. Free form scenarios allow groups to collectively play 2D and 3D immersive videogames, conduct virtual exploration, share virtual experiences, explore virtual places, and interact with objects. Free form scenarios can include objects 156 to grab the attention of the audience, and provide them with a resulting action if they move to the coordinates highlighted. Objects can be collected and/or interacted with. Objects 156 or interactive points 156 can be used to move an interactive story forward by triggering narratives or game events.

An exemplary scenario could include a detailed cityscape at night. The audience looks out of a car they are driving out into the street, the camera a view being the view from the driver's seat The audience navigates (by moving the car left, right, and forward) to a casino, on the way there is a maze of traffic and objects to get through. The audience participates by driving through interactive scenarios. The audience reaches the casino, and enters the casino to play the slots and interact with characters and objects.

2D free form and point-and-click scenarios are within the scope of the invention. For example, a character or icon viewed from above, rotated left and right by audience gestures and able to navigate freely on a 2D map and/or between fixed points on a 2D map.

Objects and Interaction Items

Interaction items 156 are provided in preferred scenarios. Interaction items 156 can be objects or places, and the any item of interest in a scenario can be designated an interaction item for game play purposes. Interaction items can be used to attract audience attention, helping to tell a story, provide opportunities for interactions, and/or achieve game objectives. Element 156 in FIGS. 22 and 35 are generic interactive objects. In FIG. 33 the interactive object 156 is a part of a building that the camera view can zoom in on for closer inspection. In FIG. 34 the interactive object is a location that the camera view can travel to.

Interactive objects can be used to move the audience towards some desired result. Interaction items 156 can include almost anything, such as a person, a tool, a key, a phone, a dragon, a car, a computer, a building, or a door into a new location. When the audience reaches an interactive spot or object in the scenario, content such as an animation and/or human speech can be played and integrated in the scenario. The content could again include almost anything to tell a story or explain a location. Interaction items may be items or places that the camera view can zoom in on. Further non-limiting examples scenario content associated with interactive items 156 include written or verbal suggestion for next steps, an explosion, a happy face, a description of what the audience is looking at, a narrator stating “well done” or other direction to encourage next steps. In preferred embodiments the audience can interact with an object by simply pointing the camera view at it—“hovering” on it—for at least a threshold amount of time. This might be quantified as a combination of (1) the camera view being pointed at or within a set number of degrees of the object, combined with (2) a Motion Index with an absolute value of less than a threshold amount (3) for at least a threshold amount of time. Motion indexes and “hovering” on object are discussed below. A Motion Index with a low absolute value indicates little or no rotation or audience movement in either direction. In some embodiments a force feedback helps the audience hover on interaction items by pushing the camera view towards interaction items which are nearby in the scenario.

Sound Capture

In some embodiments audience sounds and vocalizations are captured by one or more microphones and processed by the server.

In one embodiment any vocalizations at decibels of at least a threshold level that occur during these above scenarios are captured by the server. The vocal input is preferably captured in real time and including information regarding decibel level. The system also preferably creates and maintains a record of audience noise and vocalizations, including the volume and what content was being displayed at the time each sound was recorded. In some embodiments the sound capture is triggered every time the audience makes a noise above a certain decibel level. Other embodiments record and/or respond differently to different volume levels.

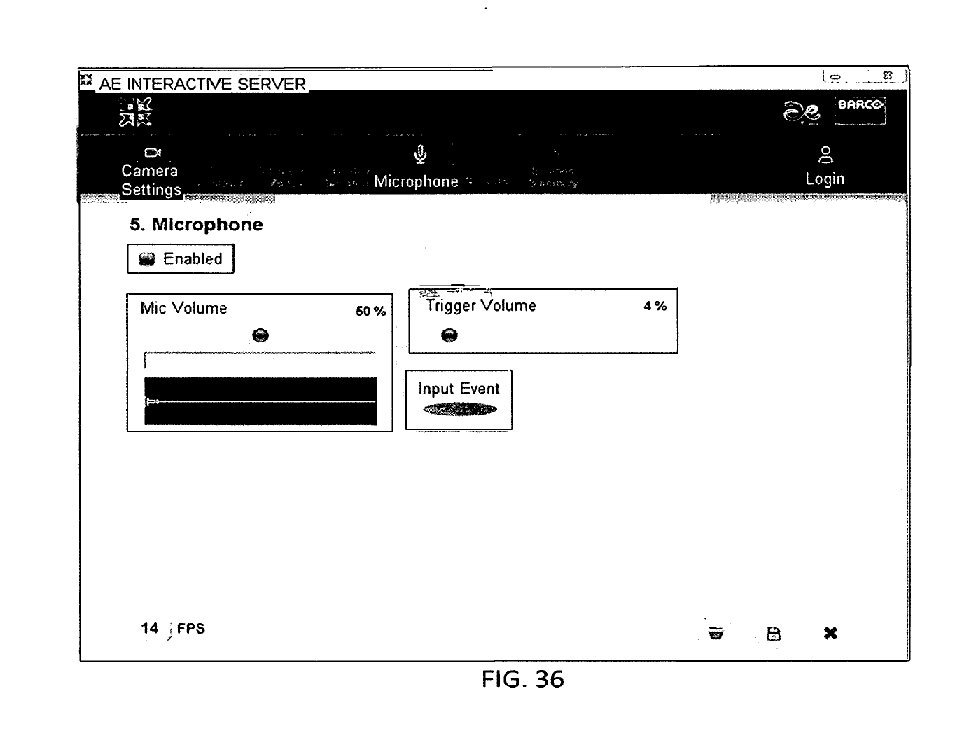

FIG. 36 is a preferred interface for controlling microphone settings. Microphone setting allows you to set the capture level that will provide the server with the best signal for processing. The trigger volume (i.e. the threshold value for sounds to be counted in a scenario) is most preferably between 2-5% depending on room size. The input event indicator shows whether the trigger is capturing sound having at least the trigger volume. In some embodiments the audience is directed to shout or applaud to vote for a preferred item or option, as a series or items or options are displayed. Volume is measured during each display, and the choice eliciting the loudest response is implemented.

Algorithms and Indexes

Exemplary embodiments include algorithms both for crowd motion detection, and for statistical purposes which provide automatic measurements of audience participation rates. These are contemplated for use with both 2D and 3D scenarios.

Exemplary embodiments of motion detection algorithms allow audiences to control applications by moving their arms and body sideways and/or vertically, the algorithms being able to recognize the directions left, right, up and down by multiple individuals and to interpret those motions into a simpler, useful value or instruction.

In an exemplary embodiment of the present disclosure, the algorithms allow the crowd to control lane based games, such as catch and dodge or brick breaker.

FIG. 1 depicts an exemplary embodiment of this disclosure, wherein the sideways motion of human participants, and especially their arms, leads to the motion of a car between two alternate lanes A1 and A2.

FIG. 2 depicts a game with sideways motion, suitable to be controlled by the methods and systems in this disclosure.

FIGS. 22 and 33-35 show audiences 150 controlling 3D scenarios by side-to-side motions.

Motion Capture: Optical Flow Vectors are Calculated from Differences Between Successive Video Frames, and are Used to Calculate Motion Indexes. Motion Indexes are Input to Control the Camera View.

This disclosure will describe two major methods that enable interactive crowd controlled navigation through 360° 3D content and/or 2D content using group motion capture, in addition to methods for single-axis group navigation through simpler content and scenarios. Variation on and hybrids of these methods are also contemplated.

In one embodiment, a method is provided for motion detection comprising acquiring a series of images of an audience in and audience area 302 comprising a current image and a previous image, determining a plurality of Optical Flow vectors by comparing the images, each representing movement of one of a plurality of visual elements from a first location in the previous image to a second location in the current image, storing the Optical Flow vectors in a current vector map associated with time information (e.g. a histogram), and calculating an intensity ratio or “Motion Index” by a process which includes comparing the most recent Optical Flow vector with one or more previous Optical Flow vectors (e.g. from the histogram).

In another preferred embodiment, a computer system comprises a processing unit, a video camera 300, a video screen 154, and a memory, the memory comprising instructions that, when executed on the processing unit acquire a series of images comprising a current image and a previous image, determine a plurality of Optical Flow vectors, each representing movement of one of a plurality of visual elements from a first location in the previous image to a second location in the current image, store the Optical Flow vectors in a current vector map associated with time information, and determine motion by calculating an intensity ratio or “Motion Index” between the current vector map and at least one prior vector map.

In yet another embodiment, a tangible, computer readable media comprises computer instructions that, when executed on a processing unit, cause the processing unit to acquire a series of images comprising a current image and a previous image, determine a plurality of Optical Flow vectors, each representing movement of one of a plurality of visual elements from a first location in the previous image to a second location in the current image, store the Optical Flow vectors in a current vector map associated with time information, and determine motion by calculating a Motion Index between the current vector map and at least one prior vector map.

The Audience Entertainment Interactive Server or AEIS is broadly conceived as systems for capturing and interpreting motions and sound in and among a group of people of any size, among other organisms, or among objects in any context for a variety of applications. In some embodiments it is a system and method for captioning and interpreting the movements and/or sounds of people in a venue or other audience, and of using such input to collect information and/or to provide control or feedback to a game or other activity being shown to the audience.

In a preferred embodiment, the AEIS interprets audience images captured by a digital video recorder, and provides a Motion Index calculated using the audience images to a simulation engine 131. The simulation engine 131 uses the Motion Index to control a virtual camera called the camera view 152 which, in turn allows the audience to interact with a scenario running in the simulation engine.

The AEIS includes a method for motion detection comprising: acquiring a series of images comprising a current image and a previous image; determining a plurality of optical flow vectors, each representing movement of one of a plurality of visual elements from a first location in the previous image to a second location in the current image; storing the optical flow vectors in a current vector map associated with time information; and determining motion by calculating an intensity ratio or Motion Index between the current vector map and at least one prior vector map.

This system includes a method for sound detection by acquiring crowd vocalizations via a microphone and computer sound card, calculating the decibel level and triggering interactive events when a decibel level exceeds an assigned threshold.

Prior to determining the plurality of Optical Flow vectors, it can be desirable to apply a difference-based filter between consecutive images in the series of images.

Embodiments can include, prior to determining the plurality of optical flow vectors, applying a polygon-based filter (e.g. an aisle mask) delimiting areas of the series of images to be excluded when determining the plurality of Optical Flow vectors. The plurality of Optical Flow vectors can be determined including by the application of a pyramidal Lukas-Canade algorithm.

Calculating the Motion Index can include the application of the following formula:

$$M ( {v}_{t} , {VPos}_{n} , {VNeg}_{m} ) = \{ \begin{matrix}\frac{B + 0.5 E}{n} .100 & if {v}_{t} > 0 \\ - \frac{B + 0.5 E}{m} .100 & if {v}_{t} < 0 \\ 0 & if {v}_{t} = 0\end{matrix}$$

wherein: B is the number of stored Optical Flow vector scores (e.g. stored in a histogram) below vt, if vₜ>0, or the number of stored Optical Flow vector scores above vₜ, if vₜ<0;

E is the number of stored Optical Flow vector scores equal to vₜ;

n is the number of positive Optical Flow vector velocities stored;

m is the number of negative Optical Flow velocities stored;

v are Optical Flow vector velocities at time t;

VPosₙ=[u₀ . . . uₙ₋₁];

where uᵢ is a positive Optical Flow vector velocity obtained in an instant ≦t (uᵢ>0),

VNegₙ=[w₀−wₙ₋₁]

and where wᵢ is a negative Optical Flow vector velocity obtained in an instant (wᵢ<0). Some embodiments include prior to storing the optical flow vectors, eliminating Optical Flow vectors with an absolute value less than a predefined threshold relative to image resolution.

The invention can include a tangible, computer readable media comprising computer instructions that, when executed on a processing unit, cause the processing unit to: acquire a series of images comprising a current image and a previous image; determine a plurality of Optical Flow vectors, each representing movement of one of a plurality of visual elements from a first location in the previous image to a second location in the current image; store the Optical Flow vectors in a current vector map associated with time information; and determine motion by calculating an intensity ratio (e.g. a Motion Index) between the current vector map and at least one prior vector map.

The invention includes generating real-time statistics referred to here as Crowd Participation Index, which includes documenting motion activity (left, right, up, down) and the motion velocity threshold collected as well as vocal crowd responses based on exceeded assigned decibel level thresholds. The captured data which are located in real-time generate log files co-located on the computer can then output captured data results in multiple formats such as graphs and text which describe the crowd response motion and sound to the content viewed.

The instructions can include, when executed on the processing unit, prior to determining the plurality of optical flow vectors, applying a difference-based filter between consecutive images in the series of images. They can also include prior to determining the plurality of optical flow vectors, applying a polygon-based filter delimiting areas of the series of images to be excluded determining the plurality of optical flow vectors. Instructions to determine a plurality of optical flow vectors can further comprise the application of a pyramidal Lukas-Canade algorithm. The media may further comprise instructions that, when executed on the processing unit, prior to storing the optical flow vectors, eliminate Optical Flow vectors with an absolute value less than a predefined threshold relative to image resolution.

Optical Flow Vectors

Optical Flow or optic flow is the pattern of apparent motion of objects, surfaces, and edges in a visual scene caused by the relative motion between an observer (e.g. an eye or a camera) and the scene. Different portions of an image will often have different Optical Flow. Sequences of ordered images can be used to estimate motion as either instantaneous image velocities or discrete image displacements. Optical flow methods may try to calculate the motion between two image frames which are taken at times t and t+Δt. In the instant invention, Optical Flow is preferably calculated by comparing sequential image frames in digital videos.

The determination of Optical Flow vectors can be performed through a pyramidal Lukas-Canade algorithm, among other known methods. The Lucas-Kanade method is a widely used differential method for optical flow estimation developed by Bruce D. Lucas and Takeo Kanade. It assumes that object flow is relatively constant in the neighborhood of the pixel under consideration, and solves the optical flow equations for all the pixels in that neighborhood by a least squares method. By combining data from multiple nearby pixels, the Lucas-Kanade method can be used to resolve inherent ambiguity of an optical flow equation. The method is also less sensitive to image noise than single point methods, although single point methods are also within the scope of the invention.

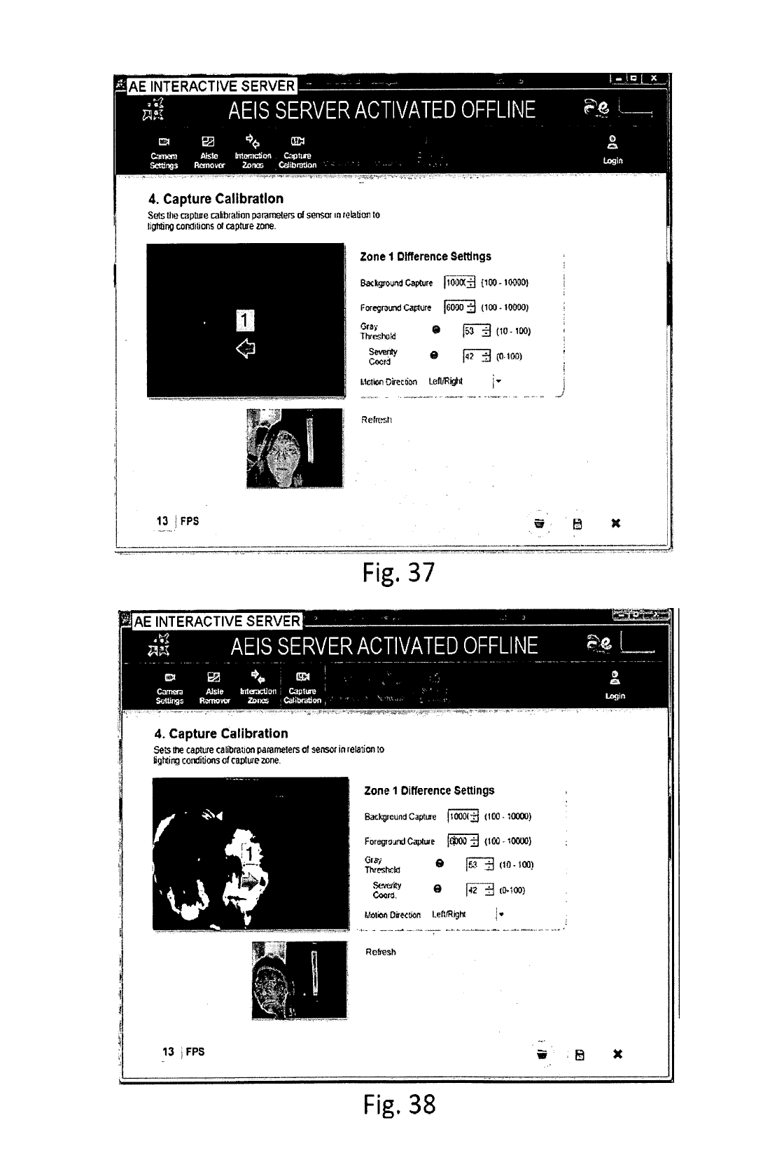

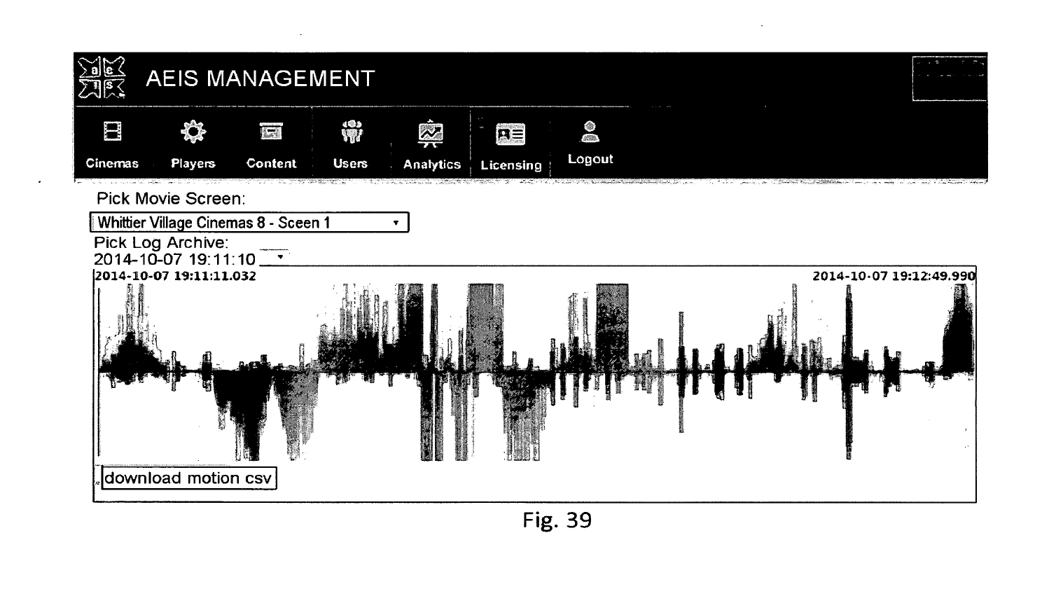

FIG. 37 and FIG. 38 are screen captures of a preferred image capture calibration tool. This tool defines and refines the parameters of sensitivity required by the sensor in relation to the actual lighting conditions of the capture zone during interactive play. In FIG. 37, the user in the lower window is sitting still, and essentially no movement is shown in the (mostly black) upper window. In FIG. 38, however, the user has moved sideways, and that movement has been captured and is reflected as white areas in the upper window.

Audience members are limited in how far they can physically gesture in each direction without leaving their seat. Optical Flow is calculated based on movement, and so audience members only create Optical Flow when they are actively gesturing. When the gesture ends, no additional Optical Flow will be created or detected by AEIS, even if the audience members remain, for example, leaning to one side. Audience members can generate continuous Optical Flow in a given direction by repeated gestures in that direction. This can be combined with minimizing the visual impact of their return to their resting position. For example, making repeated large radius arm gestures to one side, while returning the arms to the center of the body (to prepare for another large side gesture) by discretely pulling them back to the center of the body. Preferred scenarios are designed, however, to make sustained camera rotation unnecessary, and therefore to make repeated gesturing unnecessary.

Optical Flow “vectors” and “values” are considered interchangeable herein, the “value” simply meaning the numerical value (including +/− sign or direction) of a vector.

Motion Indexes

Algorithms herein disclosed are shown as indexes. Motion algorithms are divided into:

A Motion Index to quantify the amount of motion of the crowd to be used in games with a continuous range of motion, such as brick-breaker-like games; and

A Boolean Motion Index to trigger the alternative positions in lane-based games, discussed separately below. A Boolean system may be implemented by determining when a numerical (e.g. −100 to 100) Motion Index is above or below threshold values.

Both motion indexes are heuristic, adapting their values to the amount of motion captured by the camera. They work in the exact same way for a large crowd as for a single person. Heuristic methods, broadly speaking, can pertain to trial-and-error methods of problem solving, sometimes used when an algorithmic approach is impractical.

The Motion Index is a distillation of movements by multiple people, often to different degrees and in different directions, into a single numerical value which is typically and preferably between −100 and 100, but may also be between −1 and 1, −10 and 10, or another numerical range. Faster movements or greater changes between successive frames will translate to a Motion Index having a greater absolute value (positive or negative). Slow movement, with less difference between successive frames, will give a Motion Index with a lower absolute value (positive or negative). In a typical embodiment, a Motion Index of zero corresponds to no net motion, while negative Motion Indexes indicate motion in one direction, and positive Motion Indexes indicate motion in the opposite direction.

Motion Indexes preferably use Optical Flow (discussed above) as the key to measure pixel velocities between two frames and calculates an average value for the entire image. A Motion Index quantifies the direction and abruptness or speed of motion between successive image frames, typically with reference to only a single axis. Faster movements or greater changes between successive frames will translate to a Motion Index having a higher absolute value. Slow movement, with less difference between successive frames, will give a lower motion index. The motion index will typically be calculated per zone (of the image field), per camera frame.

For instance, a pyramidal Lucas-Kanade Optical Flow, that has the advantage of being available in open source implementations like OpenCV, can be used. The Motion Index is, however, suited to use any algorithm within the Optical Flow family.

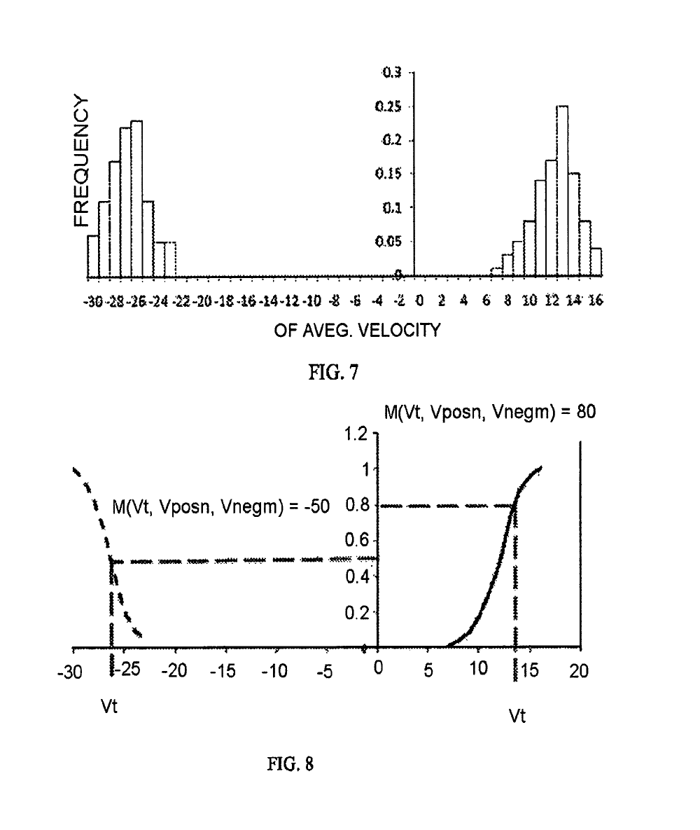

A short memory of recent Optical Flow vectors is used to calculate a histogram. See FIG. 7. Each Motion Index is preferably determined by comparing the current Optical Flow vector value with other recent Optical Flow vectors in the histogram. The system determines where in line the most recent Optical Flow vector fits among the saved recent Optical Flow vectors which are in the same (+ or −) direction. The lowest Optical Flow vector in the histogram is assigned a scale value of 1, and the highest Optical Flow vector in the histogram is assigned a scaled value of +/−1.0, +/−100, or another arbitrary maximum scale value. Compare FIG. 7 and FIG. 8. Referring to FIG. 8, a current Optical Flow vector of +14 returns a Motion Index value of 0.8, or +80. A current Optical Flow vector of −26 corresponds to a Motion Index of −0.5 or −50. Not that in this example, where the video camera 300 is not centered, Optical Flow vectors of the same magnitude (i.e. absolute value) will yield very different Motion Indexes if they are positive vs. if they are negative.

The Motion Index is therefore obtained by measuring the rank of the actual average velocity, which essentially represents a value between 0 and 100% according to the histogram shape.

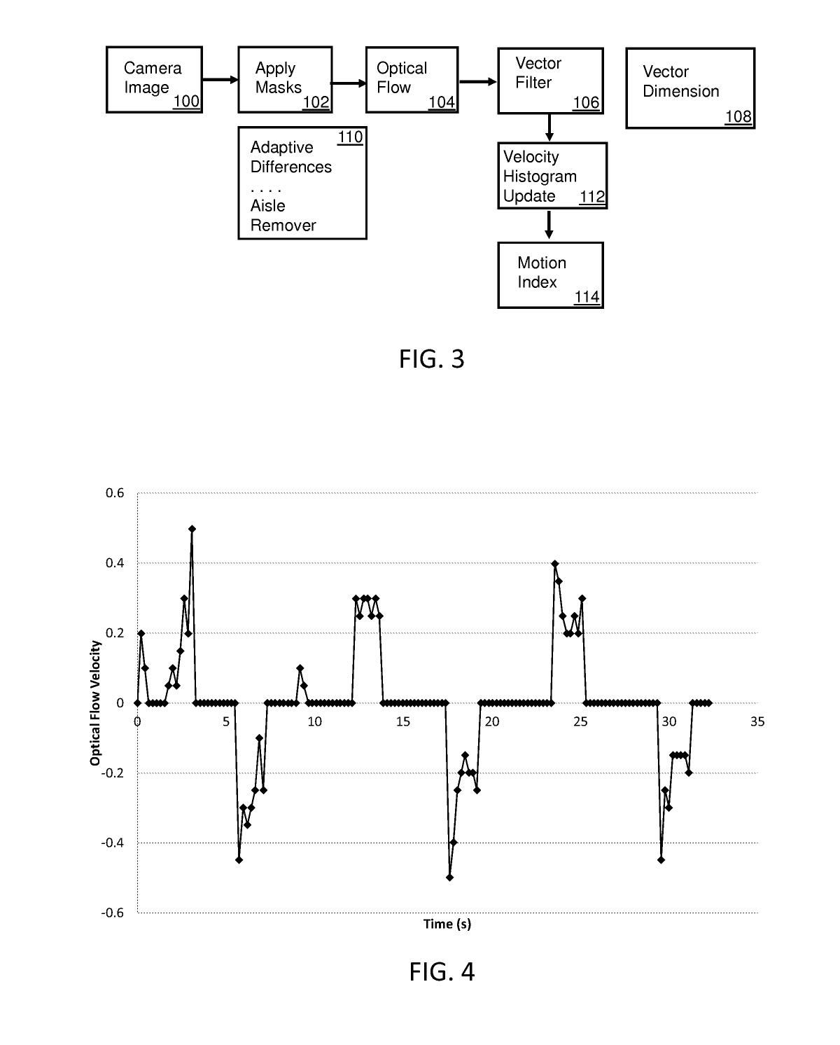

Preferably filters are used to mitigate problems with Optical Flow outliers and to optimize detection. They are used to mask pixels out of Optical Flow average velocity calculations, and also to eliminate from the calculation high velocity objects. Image processing flux can be summarized in FIG. 3. Filters can eliminate Optical Flow vectors above and/or below certain thresholds.

FIG. 3 depicts a method for calculating a Motion Index, comprising the following steps:

capture of video camera image in real-time;

first filtering, wherein masks are applied to the real-time image, to optimize detection;

Optical Flow algorithm application to determine a plurality of Optical Flow vectors;

second filtering, wherein a vector filter is applied to the optical flow vectors, for instance to remove vectors which length is above a certain threshold;

an Optical Flow velocity histogram is kept for rolling set of most-recent Optical Flow vector values, and updated with each iteration of the Motion Index; and

a Motion Index is obtained including by comparing current and previous Optical Flow vectors.

Motion Index calculation can take advantage of two different types of filters that can preferably be applied before and after Optical Flow calculation, respectively.

The first filtering level is calculated by removing certain pixels from the Optical Flow vector calculation, such as pixels which correspond to aisles. The second level of filtering is applied to filter out Optical Flow vectors after they have been calculated, such as discarding Optical Flow vectors which are too high or too low.

Motion Index calculation does not necessarily require filtering. However, filtering is performed in preferred systems to improve application accuracy.

First filtering can be performed using masks, such as an Adaptive Differences Mask, aisle removing mask, and/or a Detection Optimization Mask.

In typical embodiments, the Optical Flow values recorded in the histogram are averages for the image and/or audience as a whole. Embodiments where the histogram holds individual values for a plurality of different locations or zones are also, however, possible.

As mentioned above, a Motion Index quantifies the abruptness or speed of motion between successive image frames, as well as direction in one dimension along a virtual axis. The Motion Index is a distillation of movements by multiple people, often to different degrees and in different directions, into a single numerical value which is typically and preferably between −100 and 100, but may also be between −1 and 1, −10 and 10, or another numerical range. Embodiments where a Motion Index other than zero corresponds to no net movement are possible but less preferred.

In a prototypical embodiment, the Motion Index will be calculated once per frame, either for the entire field of view of the video camera or for all areas which are not being masked. Optical Flow values are calculated for each of a plurality of locations or zones in each image based on differences vs. the previous image, and an average Optical Flow value for the image as a whole is determined for each frame using the values for the plurality of locations or zones. The average Optical Flow value for the image as a whole for each frame (or other time period) is saved in a histogram, which may simply be values stored in a memory. A Motion Index for the image as a whole is calculated for each frame based on the latest average Optical Flow value for the image as a whole, with reference to the recent-past average Optical Flow values stored in the histogram.

In preferred embodiments, average Optical Flow values are stored in the histogram for a limited time period, and then deleted as new values are added. Preferably a histogram with a fixed maximum number of entries is maintained on a rolling basis. In this way the calculation of the Motion Index is heuristic and adapted over time.

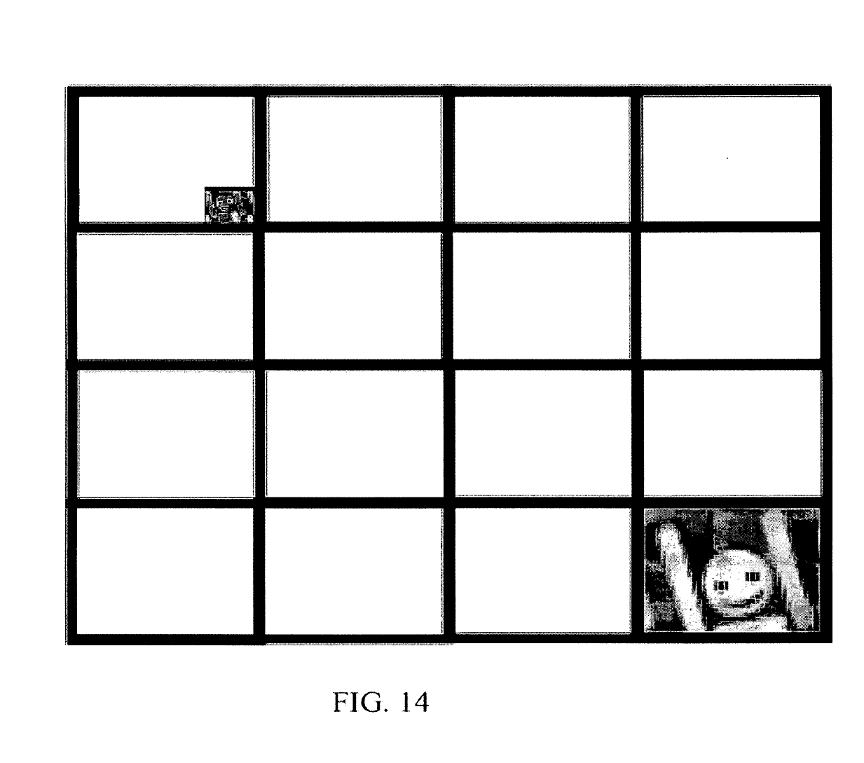

In a preferred embodiment, the camera field of view has been divided into a plurality of partition zones 250 which may be rectangular in shape. Optical Flow is calculated for each partition zone, and average Optical Flow for the image as a whole and, in turn, a Motion Index is calculated for the image as a whole. Each partition zone includes a different portion of the video camera capture zone, which corresponds to different parts of the audience area 302. As discussed in detail elsewhere in this document, zones of differing sizes can be used to ensure that areas further from the camera have the same or similar weight in determining the Motion Index than areas close to the camera. See FIGS. 14-18.

In alternative embodiments, the Motion Index can be calculated other than once per frame captured by the video camera. For example, once every time period, the time period typically being a fraction of a second.

In alternative embodiments, the plurality of Optical Flow values are calculated for a plurality of locations in the camera image without dividing the image up into partition zones.

In alternative embodiments, a Motion Index can be calculated for each partition zone 250. In some embodiments the video camera capture zone includes most or all of the audience area, and the Motion Index is calculated for the entire audience. In other embodiments the camera field of view includes only part of the audience, and the Motion Index is only calculated for that area.

In alternative embodiments, more than one camera is used, and a single Motion Index is calculated using images captured by multiple cameras.

In alternative embodiments discussed in greater detail below, the audience is divided into 2, 3, 4, or more control zones 119 which are each evaluated separately as separate teams or players. Each control zone has a separate and independent Motion Index. See FIG. 27.

When an audience is playing a game like catch and dodge, they usually move in deliberate, somewhat synchronous motions with Optical Flow average velocity peaks alternating in their sign over time as people move left and right or up and down. FIG. 4 is a typical profile for this type of game.

However, the range of Optical Flow vectors can diverge according to the area that a player occupies in the captured image, and according to camera position. In two dimensional images of a three dimensional theatre, a real-world movement of (for example) three feet in the front row of the theatre will create a much greater change in the two dimensional camera images than the same movement of three feet in the back row. Preferred embodiments compensate for this difference so that movements and participants in the front row, back row, and other rows are given roughly equal weight in calculating motion indexes and controlling scenarios.

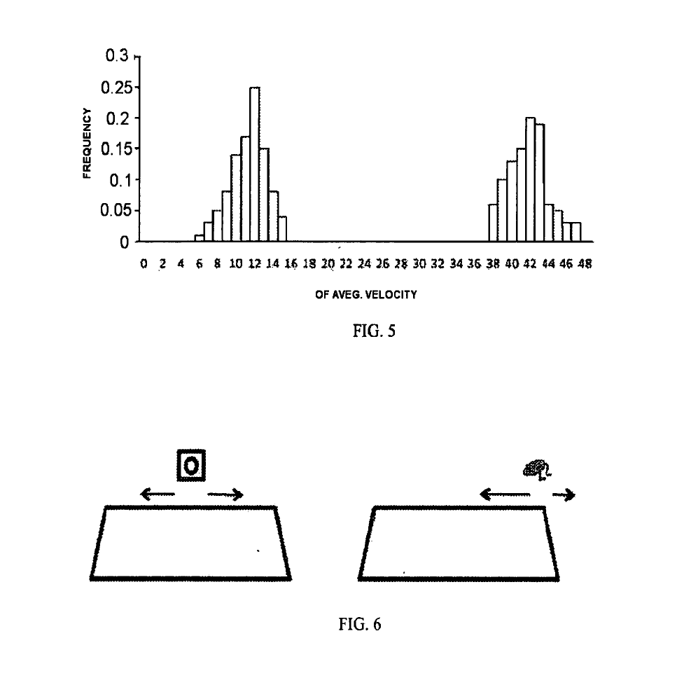

In a more concrete illustration, if a player plays the game in the front seats, and also in the back seats, the player's absolute velocities for both seat locations can be expressed by two histograms with distinct ranges like the ones in FIG. 5.

Similarly, depending on camera placement, the absolute value of Optical Flow vectors can suffer some distortion by virtue of the angle of capture and whether the camera is centered on the audience, or positioned towards one side. Typically there will be less distortion when the camera is nearer to the center of the audience (e.g. camera is directly in front of audience above a centered view screen) and more distortion of the camera is off to a side and/or viewing the audience from an angle (e.g. camera is in a corner of a theatre and capturing the audience at an angle). When the camera is off center such as in a corner of a theatre, the range and absolute value of both positive and negative Optical Flow vectors can change significantly as the angle increases. For example, if the camera is placed in the right corner of a theatre, vectors created by people moving left and right will be longer when they move left than when they move right, as illustrated in FIGS. 6-7. The Motion Index preferably integrates the foregoing considerations and optimizes key parameters. The Motion Index preferably differentiates positive and negative velocities (i.e. movement in different directions) and keeps a short memory of recent Optical Flow average velocities (e.g. a histogram). Histograms are updated as a new captured image arrives and used to (re)calculate the average Optical Flow velocity.

In one preferred method, a Motion Index is determined by considering the following Optical Flow vectors:

VPosₙ=[u₀ . . . uₙ₋₁]

where uᵢ is a positive velocity obtained in an instant ≦t (uᵢ>0),

VNegₙ=[w₀−wₙ₋₁]

and where wᵢ is a negative velocity obtained in an instant ≦t (wᵢ<0);
the Motion Index uses the rank of the current or most recent Optical Flow velocity (expressed as a percentage) as compared to recent Optical Flow vectors saved in a memory (e.g. a histogram) of positive and negative velocities (v) as:

$$M ( {v}_{t} , {VPos}_{n} , {VNeg}_{m} ) = \{ \begin{matrix}\frac{B + 0.5 E}{n} .100 & if {v}_{t} > 0 \\ - \frac{B + 0.5 E}{m} .100 & if {v}_{t} < 0 \\ 0 & if {v}_{t} = 0\end{matrix}$$

B is the number of scores in a histogram below vₜ, if vₜ>0 or number of scores above vₜ, if vₜ<0

E is the number of scores in the histogram equal to vₜ

n is the number of positive velocities in the histogram, and

m is the number of negative velocities in the histogram.

To illustrate the calculation of the Motion Index, FIG. 7 is a representative histogram for both positive and negative Optical Flow average velocities. When a new velocity is obtained, it is checked if it is positive or negative and the corresponding histogram is updated. FIG. 8 is a graph incorporating the histogram data in FIG. 7, where the lowest magnitude Optical Flow values are assigned a y-axis value of 0 and the highest magnitude optical flow values are assigned a y-axis value of 1.0. 0 and 1.0 may be scaled to Motion Index values of 0 and +/−100.

Assuming the velocity is positive with vₜ=14 we will obtain an accumulated probability of approximately 0.8 and thus the Motion Index has a value of 80. On the other end if we assume the velocity as negative with vₜ=−26, the accumulated probability is 50 and, therefore, the Motion Index is −50.

Despite positive and negative velocities having very different scales, the preferred Motion Index produces values within −100 and 100 which are adapted to the orientation of the camera.

The Motion Index is made heuristic in part by the short memory of the Optical Flow velocity histograms, where the values and therefore the scale are preferably always adapting on a rolling basis based on the amount of motion captured by the camera in the recent past, with new velocities being added as older values are discarded. Determining what fraction of the positive Optical Flow values in the histogram are lower than the current Optical Flow value (vₜ) when the current value is positive, or what fraction of the negative Optical Flow values in the histogram are greater than the current Optical Flow value (vₜ) when the current value is negative, makes the Motion Index parameterless and confined to a scaled range (e.g. −100 to 100). See FIGS. 7-8. Note that positive and negative values represent motions in opposite directions. Thus, when vₜ is negative, previous negative Optical Flow values which are greater than the current vₜ represent movements in the same value, but with a lesser magnitude.

Also useful is a computer system, comprising: —a processing unit; —memory; —a video camera; —a video screen; and —a computer application;

wherein: —the computer application is stored in the memory and run by the processing unit, taking input from the video camera and providing output to the screen; and the computer application runs a Motion Index algorithm, such as the one outlined above.

The field of view of the video camera may be referred to as the “capture zone”.

Another element useful in implementing the invention is a computer readable media containing computer instructions configured to execute a Motion Index algorithm such as the one above.

The above methods have been expressed as sensitive to a left and right sides from the perspective of a camera. The same methods can be easily adapted for use on an up and down axis, or other axes.

This can be of use in scenarios such as a sports arena for the public, or an event room with a stage wherein there is a general public section at floor level and there are elevated boxes or cabins or at least one other elevated level. The main levels of large venues can typically accommodate more spectators than a cabin section or mezzanine section.

Nevertheless, by virtue of the Motion Index, the cabin section or mezzanine will be able to influence the application or game just as much as the general audience lower down and closer to the camera.

In a computer-implemented-method, a Motion Index is computed from vectors obtained through an Optical Flow algorithm by comparing new Optical Flow vectors with a histogram of past Optical Flow vectors.

The Motion Index is used to determine maximum motion for an image or a part thereto, enabling the calculation of the proportion of motion in any point in time, relative to the maximum motion. Thus, any motion can be attributed a relative strength proportional to the actual historical maximum, which has the virtue of allowing for consistent proportional interaction for audiences of all sizes.

Boolean Index Algorithm

The Motion Index described above has a continuous nature, measuring the actual amount of motion being captured by the camera in real time, and not just the direction of the motion and perhaps whether the motion is over a particular threshold. Continuous range systems are well suited to applications requiring a continuous range of motion, such as brick breaker type games, and 3D navigation when, for example, different rates of turning are enabled. In other applications, however, it is desirable to translate group motion into only a limited set of discrete instructions, or “Boolean” motions. For example, the only allowed commands might be turn left, turn right, and face forward, with no allowance for different degrees or speeds of turning. Alternatively, two speeds of turning in each direction may be enabled, with higher, lower, and intermediate speeds being unavailable. Lane-based games, such as the one depicted in FIG. 2, require discrete values such as simple “left” or “right”, as people move to catch good items or to avoid obstacles. 3D navigation scenarios can also be designed to use only discrete commands, such as left/rig ht/forward.

The Motion Index described above can be used to calculate these Boolean motions. In a preferred embodiment, an absolute threshold for the Motion Index is specified for turning. If the Motion Index indicates left turn or right turn above the selected threshold (i.e. if the Motion Index value is positive enough or negative enough), a turn in that direction is executed in the scenario. If the Motion Index is not above the threshold in either direction, then no turn is indicated. This can be translated as an instruction to face straight forward or to continue a motion already being executed.

For example, assuming a threshold of 70%, if M(vt, VPosn, VNegm)=−89, a left order is produced. If the value were instead −69, 0, +10, +69 etc, no turn order is indicated. Similar embodiments with multiple thresholds are also contemplated. For example a slow turn at a threshold of 30%, and a faster turn at a threshold of 80%.

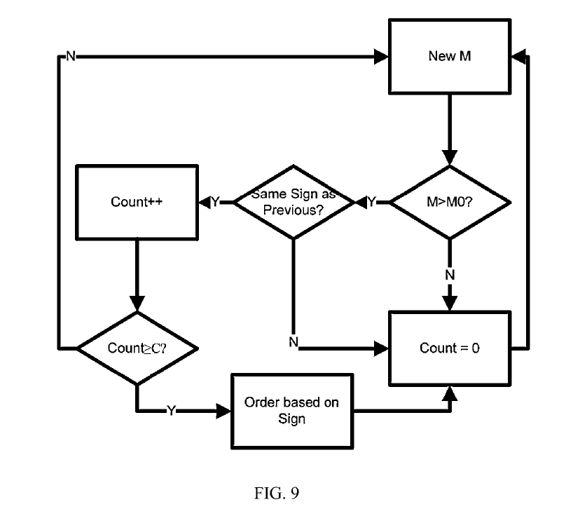

For increased accuracy, the trigger can be the occurrence of a predefined number of consecutive values (C) above some absolute threshold for the Motion Index (M0), following the flowchart in FIG. 9.

Taking M as M(vₜ, VPosₙ, VNegₘ), for each new value of M that is superior to M0 with a sign (i.e., negative or positive) equal to the previous value of M increments a counter. Upon the counter reaching a parameter C, an order is given based on the negative or positive sign of the set of C number of M values with the same sign.

Boolean arrangements can be used with either on or two axes. For example, for both up/down and left/right motion.

Adaptive Differences Mask

Adaptive difference masking is a noise elimination technique to improve Optical Flow detection. Parts of audience area 302 images captured by the video camera 300 (i.e. the “capture zone”) will be background areas, as opposed to depicting audience members. For example, empty seats, walls, the sky (in outdoors settings) are all background. Different images of these background areas may contain incidental differences—e.g. camera fuzz—which the system might wrongly interpret as audience motion. Adaptive difference masking discards small variations as presumably being noise and not audience gesturing.

In a preferred embodiment a digital filter is used between two or several consecutive frames to eliminate those pixels not showing differences in the gray scale above a predefined threshold. In a preferred embodiment, pixels which do not undergo at least a threshold degree of grayscale color change between frames are ignored when calculating Optical Flow. Comparisons can be made between a current image and a median image (e.g. median for that pixel for recent images) to determine the degree of color change.

Optical Flow detection can be influenced by extreme lighting conditions (e.g., weak light), heterogeneous lighting, and lateral lighting. Weak lighting may increase Gaussian noise in the image captured by the camera, decreasing Optical Flow precision. Heterogeneous and lateral lighting may cause two similar motions to be detected as having different intensity.

### Aisle Mask

In many venues, there is a high probability that people will be walking to and from their seats through aisles while a scenario is running, and thus while audience movements are being monitored and interpreted to control the scenario. It is therefore important to focus motion detection on the regions where audience members are likely to be focusing on and participating in the scenario. For example, in the seats of a theatre, and not exits or aisles which may also be in view of the camera(s). One way to do this is by “masking” certain areas of the video capture or field of view, typically areas that are most likely to include people who are walking or doing other activities unrelated to the scenario. This can be achieved by ignoring selected parts of the camera field of view when controlling the scenario, such as when calculating Optical Flow vectors and/or a Motion Index. Geometric areas of the camera field of view may be selected to be ignored or masked when determining Optical Flow, or otherwise filtered out of the data. Typically the excluded areas will include aisles, exits, vending areas, movie projector light, ceiling fans, and/or any other area outside of audience seating, standing, or other accommodation areas which are specifically oriented for viewing the scenario. The “aisle mask” can be used to mask areas other than aisles.

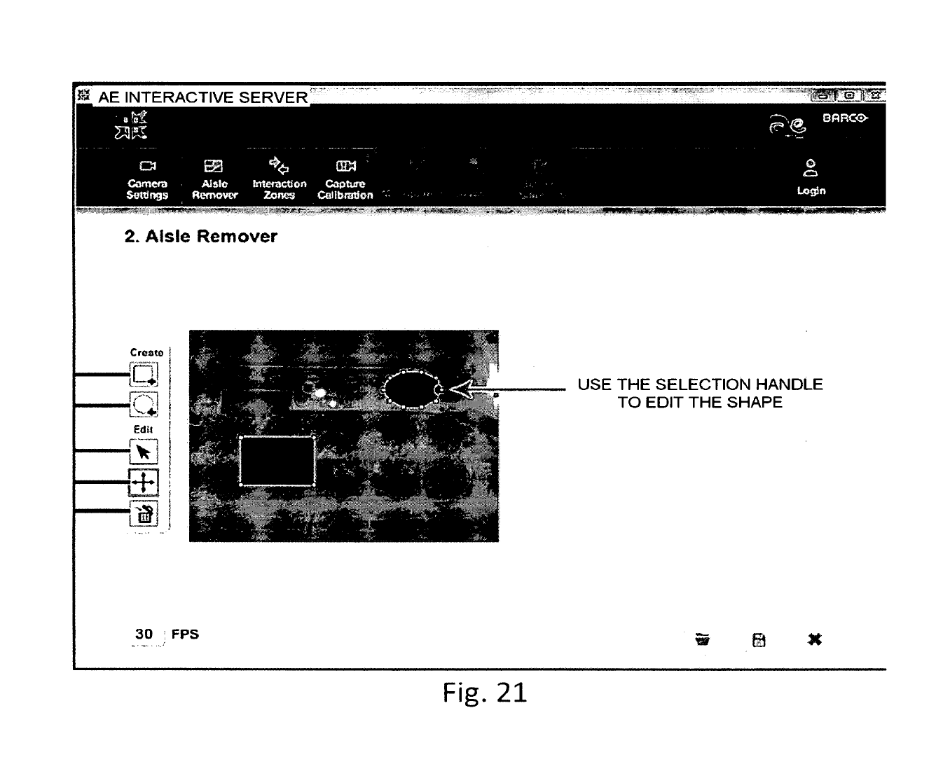

In a preferred embodiment shown in FIG. 21, persons configuring the AEIS for a given venue can “draw” shapes onto the video camera's view of the audience area (a.k.a. the “capture zone”) to be masked out. This window allows you to refine the area you are capturing to include only what we call the “capture zone”. Using tools (e.g. the arrow for editing and the crosshatch for moving) users can mask objects that interfere with the to camera sensor such as aisles and projector light. Preferred tools allow users to select, edit, and position polygonal or circular/oval masks.

Instead of or in addition to aisle masking, control zones and/or partition zones (see below) can be selected to exclude aisles and other areas of a venue. Aisle masking is useful with both 2D and 3D scenarios.

Real-Time Participation Tracking (RPT)—Participation Tracking Index

Statistics for crowd participation can be of interest. For example, to gage interest in and responsiveness to interactive advertisements, such as in a movie theatre. To that end, the invention includes the Real-Time Participation Tracking (RPT) feature, which is used to generate a Participation Tracking Index.

In one aspect of the instant invention, a Participation Tracking Index provides a statistical measure to quantify crowd participation by use of Optical Flow. The Participation Tracking Index is preferably expressed as a ratio or a percentage of the audience which is actively participating by gesturing. Alternative embodiments also estimate the audience size and actual number participating by comparing active areas (as determined by captured motion) and the known arrangement and capacity of each venue.

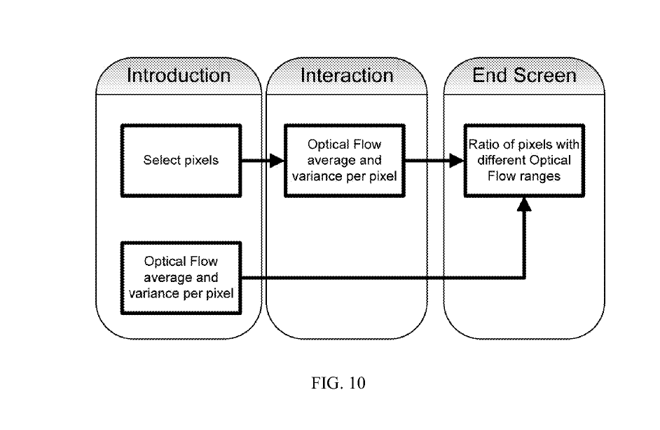

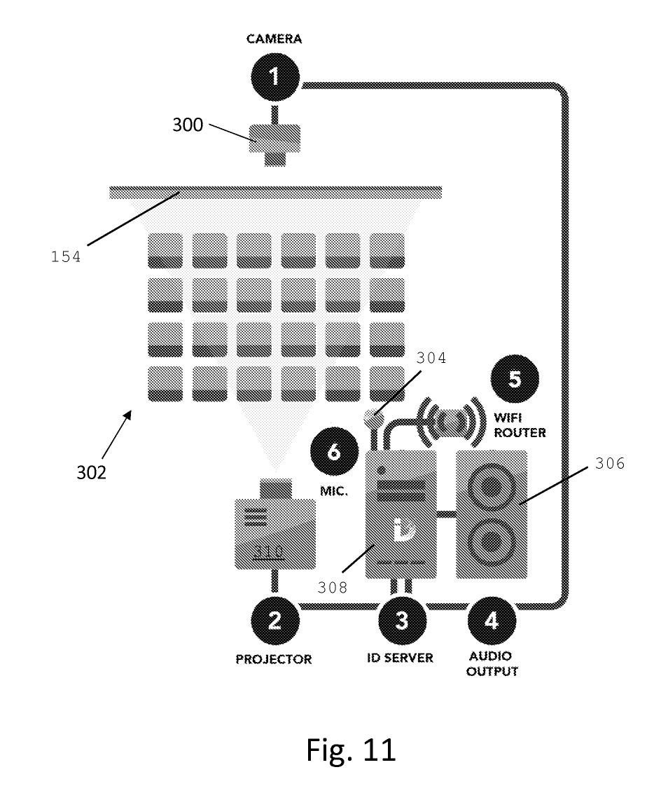

The algorithm for a Participation Tracking Index is typically carried out assuming that interactive content includes an Introduction phase, an Interaction phase, and an End Screen phase, as depicted in FIG. 10.

In the Introduction phase, the camera captures images of the audience. All of the pixels are sampled randomly over a period of time, and their respective Optical Flow vectors kept in memory. Preferably during the Introduction phase the audience is sampled as it will be composed during the Interaction phase (e.g. most or all of the audience has arrived and have selected their sitting or standing positions), but before the audience is making any effort to interact with the scenario (e.g. by waving their arms left and right during an Interaction phase). For example, the Introduction phase could be a period when a movie in a theatre has first started to play, but before an interactive scenario has started. The Introduction phase could overlap with the delivery of interactive instructions to the audience, and/or with an instruction to remain relatively still. The goal is to get a baseline reading for motion within that particular audience which is not directed to controlling the scenario in order to determine what motions, later, are directed to controlling the scenario. Some areas imaged by the camera will have low levels of motion which, it might be assumed, are created by audience members who are sitting quietly, talking to their neighbor, eating popcorn etc. Other areas might have no detectable motion and, therefore, are assumed to be empty. Aisles might have periods of no motion and occasional periods of high motion. Optical Flow for different areas of the audience can be recorded and/or used to set minimum actuation thresholds for later use during an Interaction phase. The Introduction phase can also be used to select pixels and areas which presumably contain audience members, and which therefore will be considered in determining Motion Indexes and controlling the scenario during Interactive phases. Other areas and pixels can be designated to be ignored during the Interactive phase as apparently being empty—e.g. empty seats. Such areas can be masked.

During the Introduction phase, Optical Flow may be filtered in the same way as for the Motion Index calculation (see above).

In some preferred embodiments, Optical Flow readings made during the Introduction phase are used to calculate a Participation Tracking Index based on motion detected during the Interaction phase. Areas and pixels which showed at least a threshold level of Optical Flow during the Introduction phase and which showed elevated Optical Flow during the Interaction phase (e.g. at least a second higher threshold level of Optical Flow) are assumed to be audience members who actively participate in the scenario. Areas and pixels which showed at least the threshold level of Optical Flow during Introduction and which had little or no increase in Optical Flow during Interaction are presumed to be audience members who did not actively participate in the group interaction activities. Areas which never showed at least a threshold amount of Optical Flow are assumed to be empty and can be filtered out or ignored when determining the Participation Tracking Index. The estimated audience size, and the estimated number of active participants, can be compared to estimate crowd participation and generate a Participation Tracking Index. This motion information can also be refined and supplemented with information regarding known features of the venue, such as the number of attendees or tickets sold, the number and arrangement of seats, etc.

In a preferred embodiment, if the Optical Flow value is at least a threshold amount higher in a given location during the Interaction phase than during the Introduction phase, that area is deemed to be participating. Areas where the Introduction Optical Flow was at least a first threshold level (i.e. the space is occupied) but where the Interaction Optical Flow was not at least a second threshold amount greater than during the Introduction are deemed to be non-participating audience members. The Participation Tracking Index may be given as a ratio of pixels with sufficiently increased Interaction phase Optical Flow vs. either all of the pixels in the camera view, or vs. all areas estimated to contain an audience member. The measurements and comparisons may also be made using partition zones (which will typically be rectangles) of the same or (preferably) different sizes, instead of pixels, in order to give equal weight to areas of the audience which are closer to or further from the camera.

In a preferred embodiment, pixels or rectangular zones with at least a threshold amount of varying colors, as opposed to uniform color or a selected background color (e.g. the color of empty seats), are presumed to contain audience members. Such comparison may be made suing full color or grayscale.

In a preferred embodiment, pixels or zones are selected for statistical motion comparison to determine Participation Tracking Index by checking if they cross a specific threshold as specified for the Adaptive Differences mask.

Various mathematical approaches can be used to compare Optical Flow during Introduction and Interaction times, preferably for pixels or zones believed to contain audience members. Two preferred methods are:

Analysis of Variance (ANOVA), a technique often used to compare averages through their variability range. A single factor ANOVA is applied for each pixel or zone selected for Optical Flow vector average comparison because presumed to contain one or more audience members. If the Introduction and Interaction values are statistically not equal and the average is higher during Interaction time, the analyzed pixel or zone is deemed a participating player; and

Simple comparison of percentiles; for example—if percentile 50 of the absolute value of Optical Flow vectors during Interaction time is higher than percentile 75 for the same location during Introduction time, the analyzed pixel or zone is deemed to represent a participating player.

These techniques are useful with both 2D and 3D scenarios.

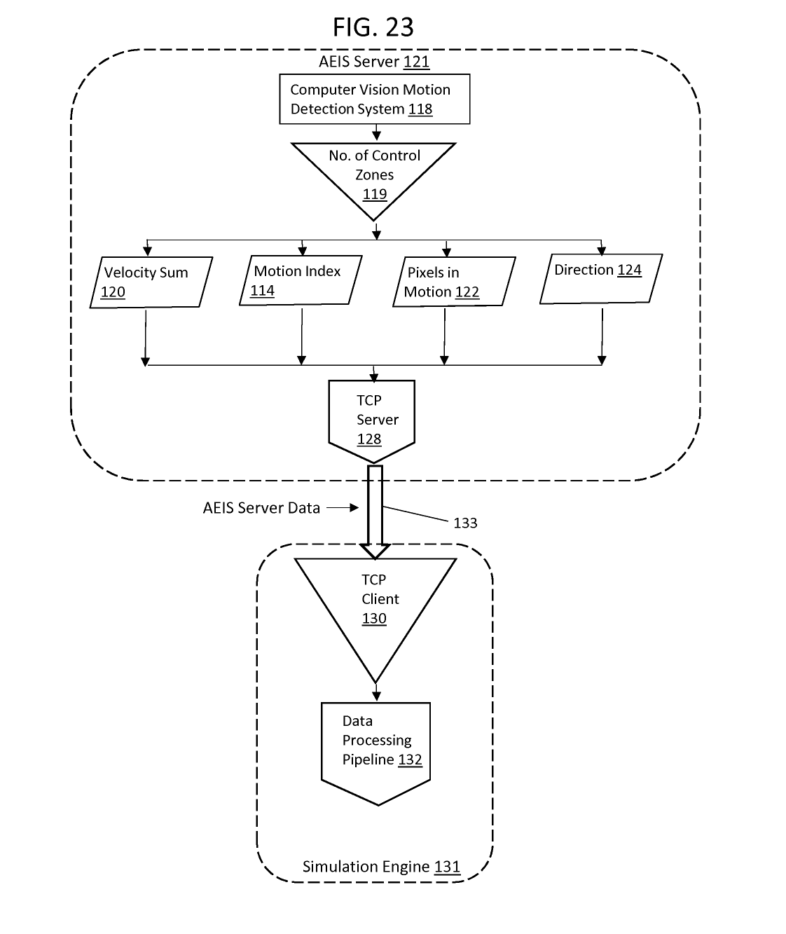

FIG. 23—Overview of Motion Detection, Image Processing, and Scenario Control

FIG. 23 is a flowchart illustrating a preferred method for capturing and processing images in an Audience Entertainment Interactive Server (AEIS) server 121, and passing 133 data derived from the images to a simulation engine 131 for controlling a scenario. The process starts in the AEIS server computer vision motion detection system. Typically this will comprise or be linked to at least one digital camera which is pointed at an audience in a viewing area such as theatre seats. The digital camera captures images of the audience area 302, which includes audience members when the system is in use. The AEIS server 121 is responsible for interpreting audience activity such as movements and sounds and translating them into inputs that can actually be used to control a game, virtual tour, or other scenario.

In the simplest embodiment there is only one control zone 119, and the entire audience interacts with the scenario as a group. Optionally, multiple control zones 119 can be calibrated, being assigned to the camera feed. See FIG. 27 which shows a theatre seating section divided into four control zones 119. Multiple control zones 119 are treated as separate “players” in the scenario, analogous to multiple players in a traditional video game who each have their own joystick or control pad. Each control zone is analyzed separately for Optical Flow, and each provides its own separate Motion Index and other output data. The control zones may be imaged by the same or different digital cameras. Control zones 119 are not the same thing as the partitioning zones 250 discussed below. The computer vision motion detection system 118 analyzes the control zones for every frame and returns values for statistics such as velocity sum 120, Motion Index 114, pixels in motion 124, direction 126, and/or other statistics for each control zone.

The Motion Index 114 is discussed in greater detail above. It is index which quantifies the amount and direction of motion in an image or part of an image at a given frame, as compared to the range of motion in the same area in the recent past. Typically Motion Index values will range from −100 to 100, with faster motion and greater amounts of motion resulting in a Motion Index with a greater absolute value (i.e. further above or below zero). The Motion Index is updated constantly while an audience is controlling a scenario, and is an important output (sometimes the only important output) of the group motion detection system for controlling scenario.

In embodiments where partition zones 250 are used, the Motion Index values of the individual partitions are preferably averaged into a single average Motion Index value at step 118. Preferably only a single Motion Index value is transferred 133 to the simulation engine 131 at a time.

Control zones 119 and partition zones 250 are not the same. In alternative embodiments a plurality of control zones each contain plurality of partition zones. Control zones and partition zones are both fully described below.

The velocity sum 120 is a measure of per-pixel velocity vectors. It is determined with reference to previous camera frames, preferably calculated per partition zone, per camera frame.

Pixels in motion 122 refers to the number of pixels that are moving per frame, in reference to previous camera frames, as a percentage. This is preferably calculated per partition zone, per camera frame.

Direction 124 in this context refers to a direction of movement—typically left or right, but up or down or other intermediate directions in alternative arrangements. In more complex embodiments where motion along two different axes is measured (i.e. two separate Motion Indexes are being calculated) four different directions are possible. The direction is determined with reference to a camera axis, and is calculated as an estimation from the velocity sum, Motion Index and pixels in motion.

Contours (not pictured): AEIS can also log and pass on the location of audience motion which is detected—e.g. where in the room and/or in the captured images the motion was. Velocity sum, pixels in motion, and direction may all be the same as or similar to the information which goes into calculating the Motion Index. In the simplest embodiments, only a single Motion Index is communicated to the simulation engine 131 to control the scenario. In alternative embodiments, however, the velocity sum, pixels in motion, and/or direction values are also or instead passed on as shown in FIG. 23.

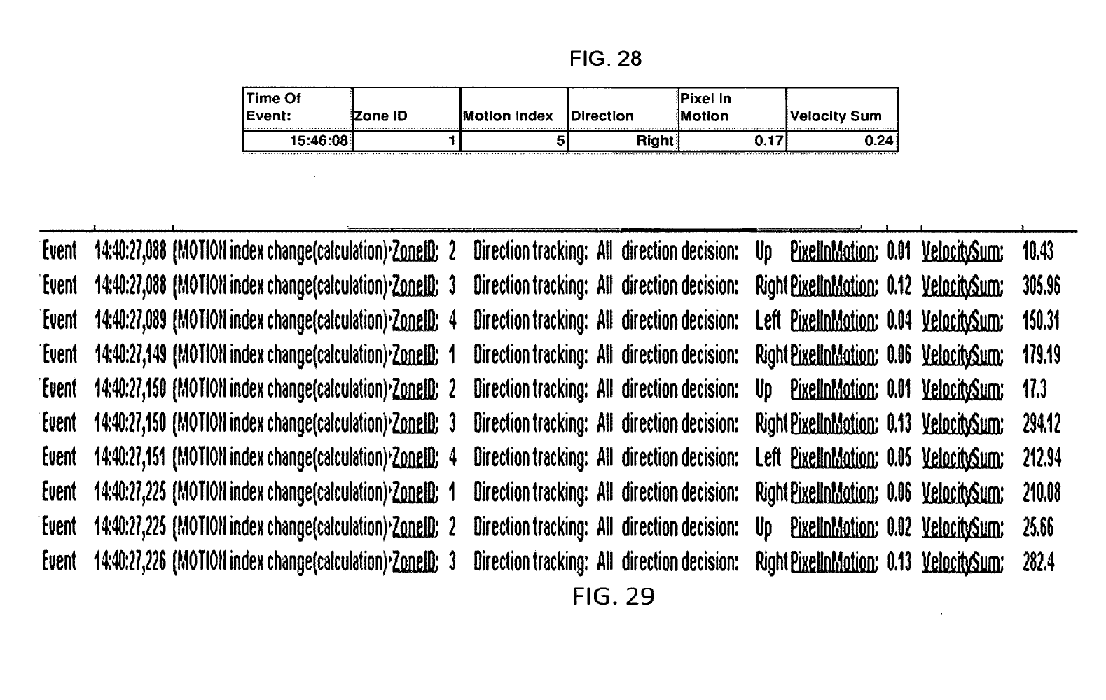

FIG. 28 shows a sample log file, having only one entry, for a single control zone 119 arrangement where only one axis (i.e. left/right) is measured. FIG. 29 shows sample data log entries from a complex, multiple control zone 119 arrangement having four control zones and a 2D motion index (up/down and left/right).

The Motion Index 114 (and optionally the other statistics) are sent 133 via TCP (Transmission Control Protocol) server 128 to the simulation engine 131. The arrow 133 indicates transmission of data from the AEIS Server component 121 to the Simulation Engine component. 131. In embodiments with multiple control zones 119, separate data will be communicated 133 for each control zone.

The simulation engine receives these values through the TCP client 130 and queues it for consumption of the data processing pipeline (132) which will later work as inputs for the interaction. TCP enables two hosts to establish a connection and exchange streams of data. TCP guarantees delivery of data and also guarantees that packets will be delivered in the same order in which they were sent.

Motion Index values can be used by the simulation engine to control scenarios as detailed elsewhere. An API (application programming interface) can be used to create games for use with AEIS. The API facilitates communication, which can be implemented using messages over local .NET sockets. Motion and control data can be transferred in XML format (Extensible Markup Language). XML is a markup language that defines a set of rules for encoding documents in a format which is both human-readable and machine-readable.

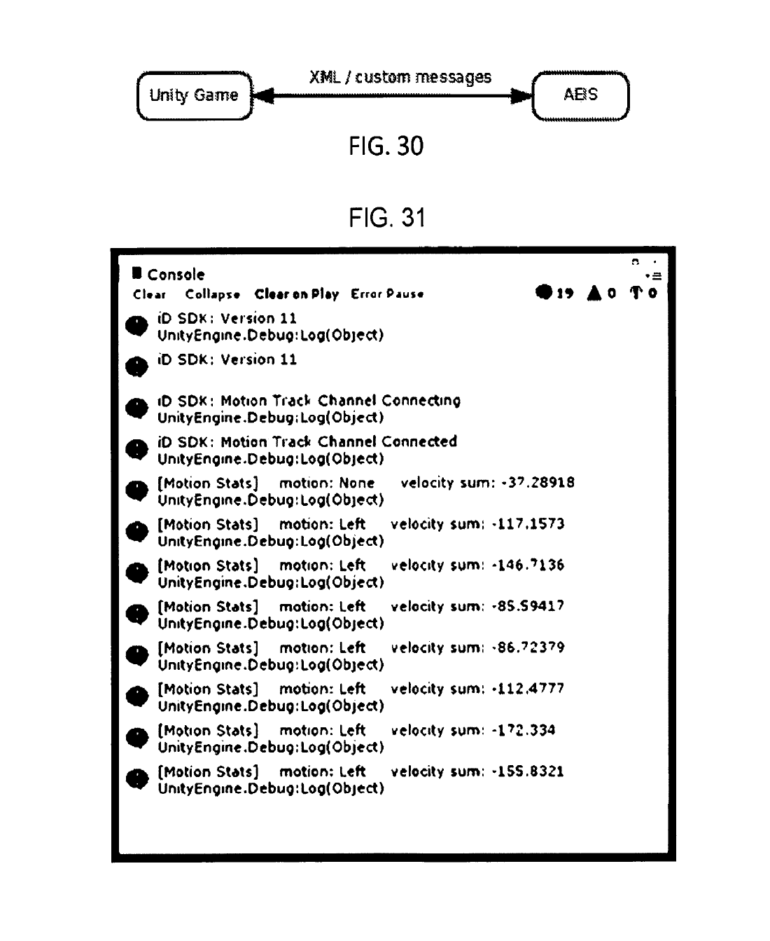

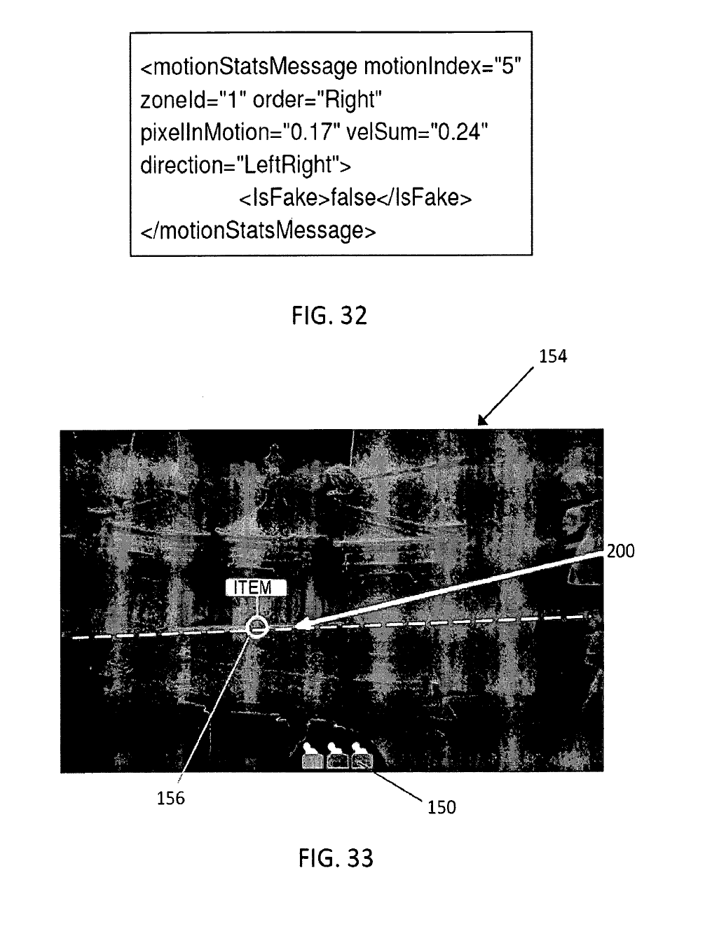

FIG. 28 is a single data log entry for a simple single control zone arrangement which only detects and uses motion on a left/right axis. In typical practice, this information or a similar set of information would be constantly updated and passed on for use controlling a scenario. FIG. 29 is a series of data log entries for a multiple control zone arrangement which is configured to detect and use both horizontal and vertical axis motion. FIG. 30 is a flow diagram of .NET socket communication between AEIS and the Unity game. FIG. 31 is an exemplary Incoming AEIS motion data report transferred 133 for a controlling a game as received by the game engine. FIG. 32 is an example of an XML format motion data report including Motion Index as well as other data.

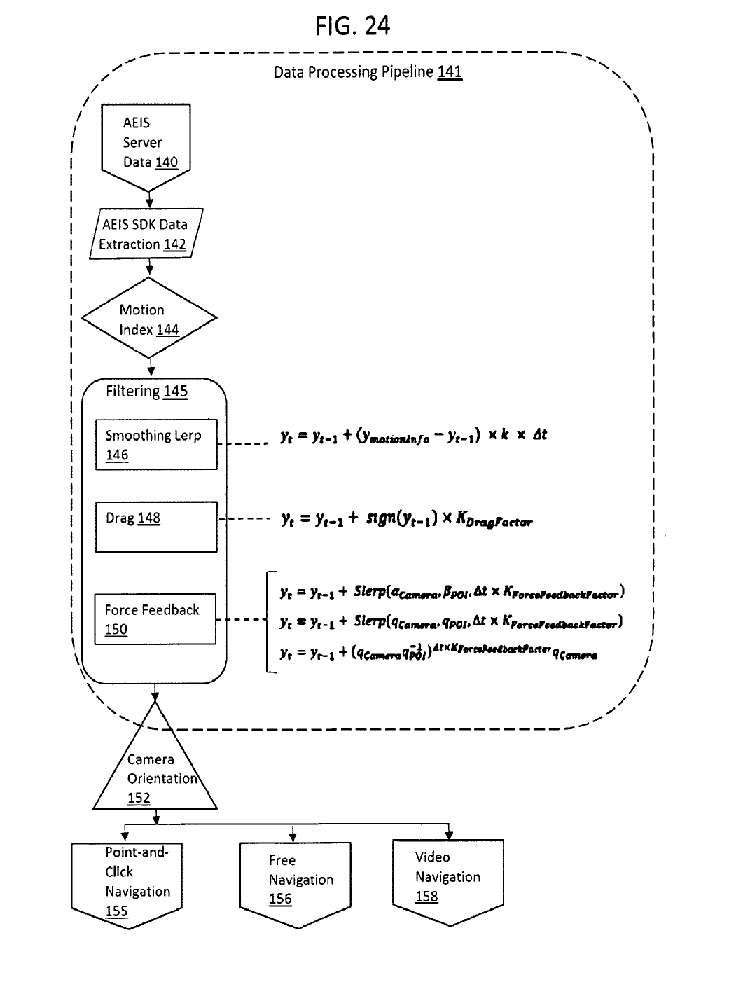

FIG. 24—Overview of Data Processing, Filtering, and Camera View Control

FIG. 24 is a flowchart showing how AEIS server data (which has been extracted from images of the audience) is received 140, processed, and used to control a camera view 152. FIG. 23 shows the relationship between the AEIS server 121 and the data processing pipeline 132, and should be considered together with FIG. 24. Controlling the orientation of a virtual camera through which the audience sees each scenario—the “camera view” 152—is how the audience navigates within a scenario. In a preferred embodiment, the Unity game creation system is used to implement aspects of this process.

Raw data is extracted by the AEIS server 121 from audience images captured by the video camera 300. In a preferred embodiment the raw data includes a Motion Index 114, and optionally also other data including pixels in motion 122, velocity sum 120, and/or movement direction 124. FIG. 32 is an example of an AEIS server data file in XML format which is received 140 by the data processing pipeline 132.

Data is extracted 142 from the data files received 140 from the AEIS server. In this example, only Motion Index data is being used, so only the Motion Index value 144 is extracted from the XML file. As shown in FIG. 32, the XML file includes several types of data. In other embodiments data other than or in addition to the Motion Index is extracted. Data extraction may be achieved using software development kit (“SDK”) data extraction programs.

Filters 145 are part of the preferred process for converting raw Motion Index data 144 into a camera view 152—i.e. the direction the virtual camera is facing. Previous camera view(s) 152 are also referenced in determining each successive new camera view. Filters are used to turn erratic group motion data (such as raw Motion Index values) into a smooth, enjoyable scenario experience.

The camera view is preferably output after the filtering process as a quaternion. Quaternions provide a convenient mathematical notation for representing orientations and rotations of objects in three dimensions.

Filters used in a particularly preferred embodiment include smoothing lerp 146, drag 148, and force feedback 150.

The following definitions apply to the preferred filter equations in FIG. 24:

y(t) is current frame;

y(t−1) is the previous frame;

y(motioninfo) is the Motion Index;

k is a configurable constant for the smoothing lerp;

Δt is elapsed time;

Kdragfactor is a configurable constant for the drag factor;

αcamera is camera angle;

qcamera is the quaternion of the camera;

βpoi is point of interest angle;

qpoi is the quaternion of the point of interest; and

Kforcefeedbackfactor is a configurable constant for the forcefeedback.

Lerp stands for linear interpolation. The smoothing lerp function 146 prevents large jumps or swings in the camera view 152. Individual Motion Index 144 values can be highly variable. Smoothing lerp prevents the camera view from jumping all at once to a new orientation when, for example, a Motion Index view with a large absolute value is received. Instead, the camera view incrementally progresses to any new point.

Drag 148 refers to a drag on rotation of the camera view 152. In the absence of continuous camera gestures indicating rotation in a given direction, the drag filter slows rotation until rotation eventually stops. This is analogous to a steering wheel on a car, which returns to a centered, non-turning orientation unless the driver continuously holds it to one side.

Force feedback 150 refers to a scenario “pushing” the camera view in a particular direction to help the audience find locations of interest and to move the scenario forward. Force feedback can be analogous to a magnet tugging the camera view in a particular direction. Typically the audience can override the force feedback if it wants to by using gestures to actively turn and move in a different direction. Force feedback can be used to tug the camera view 152 to aim directly at an interaction item or other item of interest when the camera view is already pointing near the item, making it easier to hover on the item to interact with it. In a preferred embodiment, force feedback is analogous to a compass needle which, absent other clear instructions, automatically pushes the camera view in the best direction for the audience to progress in the scenario.

In linear navigation scenarios, force feedback can be applied to rotate the camera view and/or push the audience in the forward direction.

Three alternative preferred equations are provided in FIG. 24 for implementing force feedback in a scenario.

Controlling camera orientation 152 can be used, in turn, to control a variety of scenarios within the scope of this invention. Three preferred types of scenarios in the FIG. 24 diagram are discussed in greater detail elsewhere in this disclosure. Normally only one scenario will be run at a given time.

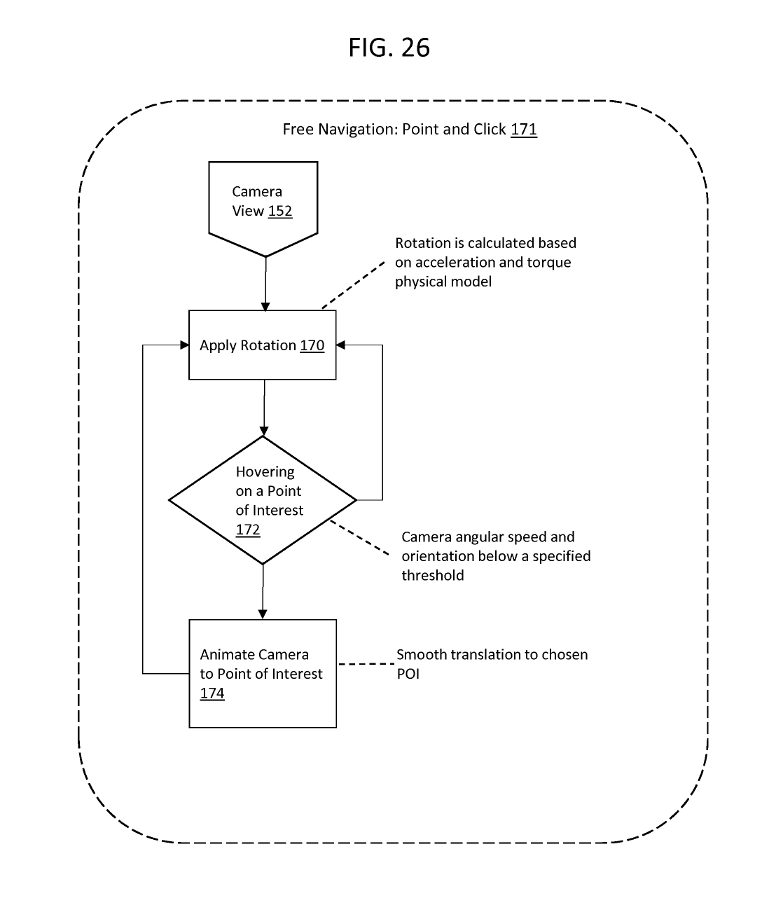

Point-and-click navigation 155 refers to navigation between a network of interaction items 156, which may be intersections, places of interest, objects etc. See FIGS. 22 and 34-35. Typically audience movements cause rotation of the camera view 152 until the audience stops rotating and looks at (“hovers on”) an interaction item for a threshold period. The camera view then moves to that interaction item 156. The audience can then rotate the camera view and select a new interaction item to visit. See FIG. 26.

Free navigation 156 refers to movement which is not limited to movement between fixed points or along specific paths. The audience rotates the camera view, and travels in whichever direction the camera view is facing. See FIG. 26.

Hybrid scenarios combining elements of point-and-click and free navigation are also part of the invention.

Linear navigation 158 refers to movement only along linear paths. See FIG. 25.

FIG. 25—Linear Path Navigation

FIG. 25 is a flowchart of navigation through a linear path type 2D or 3D scenario.

As discussed above, in some embodiments the audience moves along a one dimensional, string-like path through a scenario, controlling movement only along that path. The audience can typically rotate their field of view (or the direction an avatar is pointing in a 2D scenario) side to side and possibly up and down (in a 3D scenario), and may be able to stop, move backward, control forward motion along the path, and interact with items of interest. Linear scenarios can be used to create virtual tours through or over interesting locations, or to create walk-through interactive movies. The “path” may or may not be visible to the audience. The path may have branches and intersections. The audience can typically control which way they look by gesturing left or right, and then stopping (“centering”) when they are looking in the desired direction. In some embodiments the audience can move forward along the path by looking forward, or move backward by looking backward. Some embodiments include a default forward motion along the path to advance the scenario, and in case the audience input is mixed or inconclusive. The scenario might move forward at a slow default speed if the audience is not zooming, examining, or interacting with anything, or if time limited are exceeded. The translation velocity of the camera along a path can also be controlled by the audience in some embodiments. In a preferred version the velocity decreases as the angle away from the “forward” direction increases. For example looking forward (0°) is full speed forward, looking sideways (90°) stops the motion, and looking backward (180°) reverses the motion, moving backwards. Looking forward and to the side (e.g. 45°) can result in slow forward motion, and backwards to the side (e.g. 135°) in slow backward motion. In some embodiments moving backwards is limited or prohibited to keep the scenario on track. In alternative embodiments the velocity is held constant, or has a variable rate which is not controlled by the audience.

FIG. 25 is a flow chart for controlling navigation in one preferred linear path scenario 161. In a typical embodiment, the audience watches and experiences the scenario on a large screen from a first person perspective. An avatar 204 (e.g. a character, pointer or vehicle) facing the way the audience is facing can also be provided (see FIG. 35), so the audience is seeing the back of the avatar and watching the avatar do things. Camera view 152 in this context refers to the direction the audience is looking. See also FIG. 24. Typically the audience can control the camera view 152—i.e. the direction they are facing—using gestures to rotate the camera as elaborated elsewhere. In FIG. 22, the audience is rotating the camera left in the left frame, and rotating the camera right in the right frame. In a preferred embodiment a Motion Index derived from audience movements is used to control camera rotation.

The camera moves or “translates” 162 along the path as the scenario advances. In embodiments where the velocity of the translation V_{camera} is controlled by the camera angle α_{camera,} the velocity of camera translation could be determined by the relationship:

$$VCamera = ( 1 - \frac{α Camera}{90} ) ,$$

Wherein 1 refers to 100% of the top allowed speed, and α_{Camera} refers to the angle of the camera away from the “forward” direction. For example, if the camera is pointed exactly in the forward direction, α_{Camera} is zero, and so V_{Camera}=1 or 100% of the maximum forward speed set for that location and scenario. If the camera is pointed 45° to the left or the right of the forward direction, V_{Camera}=(1−(45/90))=(1−0.5)=0.5, or 50% of the maximum forward speed. If the camera is oriented perpendicular to the forward direction, 90° to the left of the right of the forward direction, V_{Camera}=(1−(90/90))=(1−1)=zero and the audience is looking sideways and staying in place. If the camera is pointed backwards, 180° away from the forward direction, V_{Camera}=(1−(180/90))=(1−2)=−1, and the audience moves away from the forward direction, backwards, at 100% of the maximum speed.

The above values may be tempered using additional rules, and other calculation methods are, of course, possible. For example, backward motion may be prohibited, so that any α_{Camera} of 90 or more results in standing still instead of backwards motion. The maximum backwards speed may be set lower than the maximum forward speed. A “force feedback” may be also applied where the camera view is biased or “pushed” to look and/or move in the “forward” direction along the virtual track, to move the scenario forward and/or to prevent the audience from getting bogged down in one spot.

Continuing in FIG. 25, at 164 camera rotation and translation (i.e. movement along the linear path) are applied. This “step” may be applied repeatedly or essentially constantly during a scenario. The camera angle may be rotated based on a Motion Index derived from audience gesturing. Camera translation may be at a predetermined speed set by the scenario, or may be determined based on camera angle α_{Camera} or otherwise. The display on the audience view screen is continuously updated so that the audience sees and experiences the translation and rotation.

The example in FIG. 25 includes one or more intersections 166. This is typically a point in the linear path where there is more than one option for going forward. An intersection might be a simple fork in the road in a scenario. For example, the audience may have a choice between continuing in the forward direction down a hallway, entering a room on their right, or turning down a different hallway on their left. The audience could choose which direction to go in by rotating to face their preferred direction, and then remaining facing or hovering 168 in that direction for a threshold amount of time. The scenario might include a default direction in case a large audience is unable to reach a consensus and select one option within a certain period of time.

The audience may select a path at an intersection or interact with an item or character by simply facing or “hovering” on the path, item, or direction of interest for a threshold period of time. Hovering on or near a point of interest may be defined by the camera (1) being rotated to within a set number degrees (e.g. within 0, 1, 3, 5, 8, 10, 12, 15, 20, 25, 30, or 35 degrees in either direction) of pointing directly at the point or the object, and (2) having less than a threshold rotational or angular speed, optionally (3) for at least a threshold amount of time. I.e., looking directly at or very near the relevant item or direction, without searching around from side to side, for at least 1, 2, 3, 4, or 5 seconds or some other threshold time. Hovering in a direction may also be defined as looking at or close to the element while the absolute value of the Motion Index remains below a threshold level for a threshold period. This avoids accidentally selecting items or paths when the camera is simply scanning the area.

In some embodiments a force feedback 150 function pushes the camera view towards a point of interest when one is nearby.

FIG. 26—Free Navigation and Point and Click Navigation

FIG. 26 is flowchart of navigation through a free-form or a point-and-click movement 2D or 3D scenario 171.

Point-and-click navigation 155 refers to navigation between interaction items 156, which may be intersections, places of interest, objects etc. See FIGS. 22 and 34-35. Typically audience movements cause rotation of the camera view 152 (until the audience stops rotating and looks at (“hovers on”) an interaction item for a threshold period. The camera view then moves to that interaction item 156. Free navigation 156 refers to movement which is not limited to movement between fixed points or along specific paths. The audience rotates the camera view (or the direction an avatar is pointing in a 2D scenario), and travels in whichever direction the camera view is facing. Preferred free navigation scenarios move the camera view or avatar forward continuously, with the audience steering but not controlling acceleration. Alternative preferred scenarios only move the audience or avatar forward when they look in a given direction for a threshold period of time. Forward motion can be halted when the camera view rotates a threshold distance, resulting in an alternating rotate-move forward-rotate-move forward navigation.

Hybrid scenarios combining point-and-click and free navigation are also part of the invention.

In free navigation embodiments, the audience can move through virtual 2D or 3D space freely. For example, walking at will (e.g. by turning and looking/centering where they want to go) through a maze, dungeon, or real or virtual city having objects and characters to interact with. Motion can be constrained and directed based on the “map” of the virtual place. An algorithm may be used to detect when the audience is sufficiently near and/or staring at (“hovering on”) an interactive object or location, and may zoom in towards it.

An exemplary free navigation 3D scenario could include a cityscape at night. As with linear navigation scenarios, the scenario will typically be shown on a large screen 154 from a first person perspective. In some instances with a first person avatar. The audience can look around at the city, (i.e. rotate the camera), and the scenario navigates the audience towards places, objects, and directions that the camera hovers on. Navigation in the virtual environment may be completely free-form, or (in a point-and-click scenario) may be limited to movement between a finite number of selected points, with the audience selecting nearby points to visit by hovering on or near them.

Camera view 152 in this context refers to the direction the audience is looking. Typically the audience can control the orientation of the camera—i.e. the direction they are facing—using gestures to rotate the camera as elaborated elsewhere. In FIG. 22, the audience is rotating the camera left in the left frame, and rotating the camera right in the right frame. In FIG. 34 the audience 150 is rotating left towards a point of interest 156, and will navigate towards that point of interest 156 if they stop rotation at that point. In another preferred embodiment, the audience may be constantly moving forward, but able to steer left and right as they do so. Constant forward motion is also consistent with FIG. 34.

The direction that an avatar (such as a character or a vehicle) is pointing can be used analogously to the camera view direction in view-from-above 2D scenarios.

Continuing in FIG. 26, at 164 camera rotation is applied. This “step” may be applied repeatedly or essentially constantly during a scenario. The camera angle may be rotated based on a Motion Index. The display on the audience view screen 154 is continuously updated so that the audience sees and experiences the rotation.

The audience may select a direction to travel in or interact with an item or character by simply facing or “hovering on” 172 the path, item, or direction of interest for a threshold period of time. Hovering on an item or point of interest 172 may be defined by the camera view (1) being rotated to within a set number degrees of pointing directly at the point, and (2) having less than a threshold rotational or angular speed, optionally (3) for at least a threshold amount of time. I.e., looking directly at or very near the relevant item or direction, without searching around from side to side, for at least 1, 2, 3, 4, or 5 seconds or some other threshold time. Hovering in a direction may also be defined as looking at or close to the element while the absolute value of the Motion Index remains below a threshold level for a threshold period. This avoids accidentally selecting items or paths when the camera is simply scanning the area.

Once the audience camera has hovered on a point of interest 172 sufficiently to trigger the scenario, the camera is animated towards the point of interest 174. Preferably this is a smooth, animated translation which the audience watches on the view screen 154 as if they themselves were moving. If the point of interest in an interactive object (e.g. an item to pick up, a person to talk to, a button to push) either the interaction takes place, or the audience is offered the opportunity in interact, depending on the scenario. In some embodiments the audience is always moving between discrete points, and is automatically navigated from the first point to the second point once they hover on the second point. In other embodiments, the audience can move in an arbitrary direction for an arbitrary distance by hovering on that direction. In some embodiments the audience will continue in said direction either until an object or an interaction point is encountered, or until the audience causes the camera to rotate at least a threshold distance away from the direction they are moving—i.e. until they look someplace else by gesturing in a different direction.

Once the camera has been navigated to the point of interest, the camera can again be rotated 170 to view the surrounding area, and a new direction or point of interest to move towards can be selected by hovering on it 172.

### Hybrid Linear/Free Form Navigation Scenarios

Hybrid free form/linear scenarios where movement is allowed along a large but finite web of paths with a large number of intersections are also contemplated. For example, a city scenario where every street has a linear path, and where the paths intersect at intersections, and branch off into buildings or other places of interest. The audience can navigate throughout the city, as opposed to along a single linear path, but is still limited to moving forward and back along defined lines. Speed and direction of travel can be determined with reference to the camera facing down any path (or not), without the need to designate forwards vs. backwards.

Control Zones—Splitting the Audience into Teams

The audience can be split into multiple control zones 119 (e.g. 2, 3, 4, or more) that are independent in terms of motion detection and the resulting output. See FIG. 27 which shows a theatre seating section divided into four control zones 119. Multiple control zones 119 are treated as separate “players” in the scenario, analogous to multiple players in a traditional video game who each have their own joystick or control pad. Each control zone is analyzed separately for Optical Flow, and each provides its own separate Motion Index and other output data. The control zones may be imaged by the same camera, or by different digital cameras pointing at different portions of an audience. Control zones 119 are not the same thing as the rectangular partitioning zones 250 discussed below.

Control information (such as Motion Index values) can be communicated to the simulation engine associated with a motion zone number to let the game know which zone produced the reported motion. See FIG. 29. One example of use would be a game that has two characters to be controlled by the audience. For this game, AEIS would be setup to split the audience into two control zones 119 or groups, with one group controlling a first character as outlined above and the other group controlling the other character in the same manner. In one 2D embodiment, the audience is split into two control zones which play a ball bouncing game such as brick-breaker or pong against each other. In first person 3D scenarios the view screen may be split into multiple camera views. In view-from-above 2D scenarios, each control zone may control a different avatar (e.g. character or vehicle) and the view screen may or may not be split into multiple sections for each control zone and avatar.

FIG. 29 shows sample data logged from a multi-zone arrangement having four zones and a 2D motion index (see below). Note that control information is logged for each of zones 1-4 separately.

Improved Motion Tracking Server—Crowd Participation Index

One key feature of the present invention is an improved motion tracking server (“MTS”). The improved MTS exposes and mitigates shortcomings of current tracking algorithms. The improved MTS minimizes motion imbalances caused by large difference in the number of pixels occupied by people in the front seats compared to those seated in the back seats.

A typical prior art motion tracking algorithm does not differentiate pixels: all pixels are either eliminated from consideration, or else given equal weight. Assuming Optical Flow is determined at a plurality of locations in video images of a theatre, the magnitude of the Optical Flow values will usually be higher in areas of the image corresponding to participants and areas of the venue further away from the camera. Prior art Motion Indexes are therefore based on an average of imbalanced velocities when the distance of the audience to the camera is heterogeneous.

Partition Zones

Some embodiments of the present invention minimize the camera distance effect by dividing the video capture area into smaller partition zones 250 (which may be rectangular in shape) and calculating a Motion Index separately for each of them. See FIG. 14. Zones corresponding to areas further from the camera may be made smaller than zones for areas closer to the camera. Each partition zone 250, regardless of size, returns Motion Index values using the same scale (e.g. −100 to 100) which are calculated with reference to an Optical Flow histogram specific to that zone. This scaling compensates for the higher and lower absolute Optical Flow values in different zones based on their distance from the camera, the different type or number of participants in that zone, or other factors. Each zone produces Motion Indexes (e.g. in the −100 to 100 range) regardless of proximity to the camera and amount of motion. In some embodiments, an average of all the Motion Indexes from the various partition zones for each frame is calculated, and this average Motion Index is used to control rotation of the camera view.

Partitions 250 and partition zones 250 are equivalent terms.

Embodiments using partition zones can all be used with multiple axis arrangements which include, for example, both up/down and left/right control.

The instant invention includes methods and arrangements which include dividing the camera field of view into a plurality of partition zones 250 which may be rectangular or another shape, and which may be that same or different sizes. The methods and arrangements can include calculating Motion Indexes separately for each zone using Optical Flow values from just that zone and maintaining a histogram specific to each zone. This preferably further includes calculating an average of all the single zone Motion Indexes and using the average Motion Index to control a scenario. In some embodiments, the field of view is divided into zones manually for each arrangement, such as when a given theatre or event is being set up and calibrated. Zones which would be expected to contain roughly equal numbers of viewers are preferred, where applicable.

As shown in FIG. 14, in some embodiments the MTS divides the capture area into partition zones which are shaped as uniform rectangles 250, and calculates a Motion Index for each of them. A final Motion Index is generated, which is typically an arithmetic average of some or all of the individual Motion Indexes.

This partitioning strategy has several advantages compared to prior art motion tracking servers. FIG. 14 illustrates an example in which there is a player in the back row of the room, such as an auditorium, and a second player in the front row. Because motion Index will be calculated based on the average of each individual partition zone 250, they will each have more or less the same weight in final Motion Index calculation. Different weightings for different partition zones are also possible.

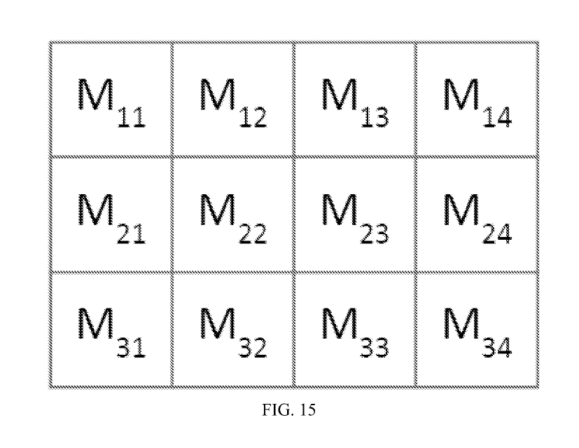

In a preferred embodiment, a user specifies a number of rows and columns, as shown in FIG. 15. The system then keeps a short memory (e.g. a histogram) of the average velocity for each partition zone. The motion index is based on the average of each individual partition 250, which may be according to the formula:

$${M}^{t} = \frac{{Σ}_{i = 1}^{Rows} {Σ}_{j = 1}^{Cols} {M}_{ij}^{t}}{Rows Cols} .$$

Static Partitioning with Variable Grid

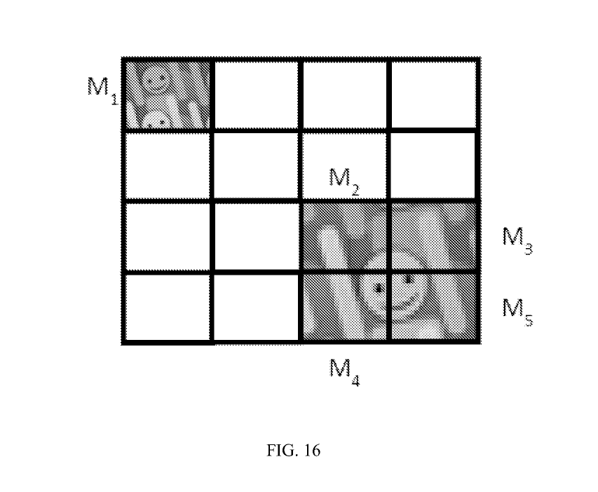

In a preferred implementation, static partitioning with variable grid is accomplished by dividing the capture area into non-uniform rectangles (P) 250 following a quad tree, as exemplified in FIGS. 16-18. Different numbers of rectangles, zones which are not rectangular, and rectangles/zones 250 in a variety of sizes and proportions are contemplated. Embodiments where variable grids are designed without using a quad tree are also within the scope of the invention. A grid with partition zones 250 of variable sizes can be designed by a user, or established using rules such as by the dynamic partitioning process described below.

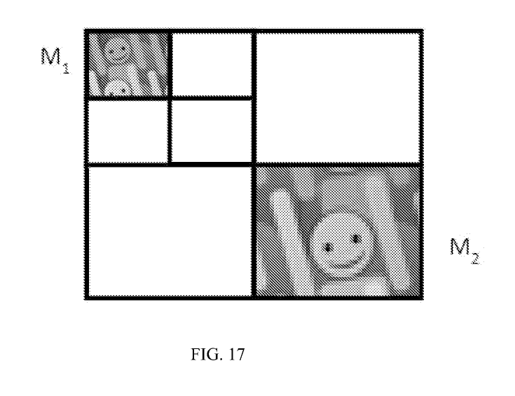

Variable grid embodiments also typically calculate a Motion Index for each partition zone 250 for each frame. The final or average Motion Index is typically an arithmetic average of the individual Motion Indexes, giving equal weight to the Motion Indexes regardless of the size of the partition zone they represent, although varied weightings are also possible. In contrast to embodiments using static partitioning with a uniform grid (e.g. FIG. 14), however, both the front player and the rear player occupy a similar portion of their respective zone or capture area, as illustrated in FIG. 17.

Using a 4×4 matrix as shown in FIG. 16 (to keep the example simple), the player in the back seat (Player 1) will occupy one partition 250 and player in the front seat (Player 2) will occupy four. Player 2 will have fully four times the weight as Player 1 because Player 2 will, on their own, determine the Optical Flow and Motion Index for four zones 250, while Player 1 motions will only control Optical Flow and Motion Index in a single partition zone. In an embodiment where the overall Motion Index is an average of the Motion Index for the component zones 250, Player 1 and Player 2 will have the following weights:

$${PlayerWeight}_{1} = \frac{{M}_{1}}{{M}_{1} + {M}_{2} + {M}_{3} + {M}_{4} + {M}_{5}}$$

$${PlayerWeight}_{2} = \frac{{M}_{2} + {M}_{3} + {M}_{4} + {M}_{5}}{{M}_{1} + {M}_{2} + {M}_{3} + {M}_{4} + {M}_{5}}$$

This means that:

PlayerWeight₂≈4×PlayerWeight₁

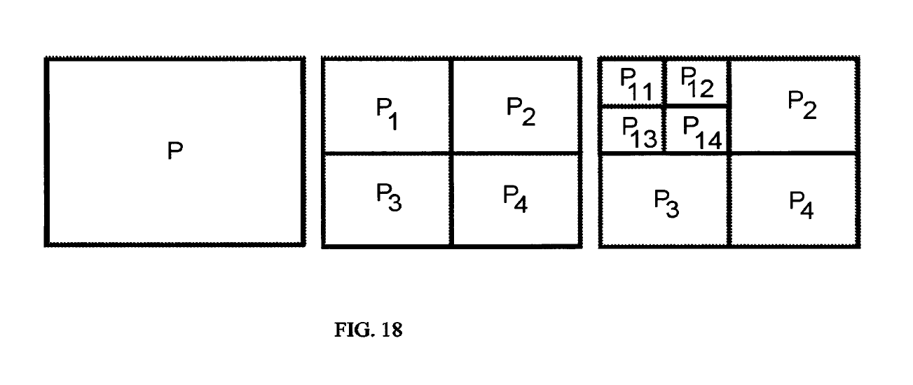

However, if the upper left zone is divided into 4 rectangular partition zones 250 and the lower right quadrant is a single larger rectangular partition zone (FIG. 17), the weights of Player 1 and Player 2 become essentially the same. This equal weighting is also despite the fact that Player 1 and Player 2 will have different Optical Flow velocity ranges in absolute terms. Note that Motion Indexes are calculated by comparing the current Optical Flow reading for each partition zone with recent past Optical Flow values recorded in a histogram for that same zone. Motion Index is thus preferably scaled to local conditions. With reference to FIG. 18, for user-directed partitioning, a graphical user interface (“GUI”) can be used to create partition zones for each venue. In other embodiments discussed below, partitions may be carried out by recursively dividing each area in 4 until a desired level or partitioning is achieved in each areas of the camera field of view. Partitions (or “partition zones”) 250 can be divided down to different depth levels, resulting in zones of different sizes. FIG. 18 illustrates an exemplary partitioning organization.

In use, Optical Flow is typically measured separately for each partition zone, regardless of its size. The algorithm keeps a short memory of the average velocity for each partition in a histogram specific to that partition zone. The overall Motion Index may be based on the average Motion Index of each individual partition, according to the following formula:

$${M}^{t} = \frac{{Σ}_{i = 1}^{Tot Partitions} {M}_{i}^{t}}{Tot Partitions}$$

Dynamic Partitioning

The size and number of partitions 250 may be calculated based on a recursive partitioning strategy that tries to find areas of “homogeneous” velocities which, presumably, include only a single participant. Partition zones 250 may be calculated as often as for each frame, but typically less often. In one preferred embodiment, recursive partitioning is used to, as best possible, achieve a one-to-one correspondence between partition zones and human participants. The invention also includes embodiments where the partition zones are determined for each venue, for each setup, or for each session, but where the partition zones are selected by recursive partitioning instead of manually.

Dynamic partitioning typically starts with a single square or rectangular partition 250, which may represent the entire camera field of view or “capture zone”. The algorithm tries dividing the rectangle in 4 new, smaller zones of equal size. This division is maintained if at least one of the four resulting partitions 250 shows a statistically different average Optical Flow and/or Motion Index from other partitions in that foursome. If no difference, or no difference above a set threshold is detected, the division in undone and the original, larger partition zone retained. In a preferred embodiment, each division is retained if a qualifying difference is detected in k frames or another unit of time. If no sufficient difference is detected within k frames, the division is discarded.

The process can be repeated with each new, smaller partition zone 250 which is created and retained to determine if further sub-division will capture new differences. The repeated process of sub-dividing partition zones and determining if new information is captured by the subdivision—i.e. the sub-divided boxes are different or sufficiently different from each other—can be used to drill down until each partition zone is different from at least some of its neighboring zones, and preferably includes only a single participant.

The dynamic partitioning process may be run continuously, periodically, or only once per show or scenario, preferably at the beginning.

Embodiments where larger partition zones are divided into other than four subzones for each iteration are also contemplated. For example, two or six sub-zones can be used with all embodiments.

In alternative embodiments, two or more adjacent partition zones which have identical or sufficiently similar Optical Flow and/or Motion Indexes for k frames or for a set period of time can be automatically merged into a partition single zone. This may be paired with, separate from, or after the partition zone subdivision and testing process. In a preferred embodiment, a subdivision and testing process is followed by a separate step where similar partition zones are merged together, regardless of whether they were ever part of the same larger partition zone.

In some embodiments, Optical Flow values (such as in a histogram) for a larger partition zone are transferred to the four smaller partition zones they are divided into so that Motion Indexes can immediately be calculated for the new trial zones. When a rectangle is divided in 4 new partition zones, the history of velocities to calculate each individual Motion Index is already there.

When smaller partition zones are merged because their Optical Flow or Motion Index values are not sufficiently different in k consecutive frames or for a given period of time, their histogram data (which are presumably similar) can, optionally, be merged as well so that Motion Index can immediately be calculated for the larger merged box. Alternatively, one of the smaller partition zones' histogram can simply be transferred to the larger merged zone since they are all presumably similar.

In dynamic partitioning, a threshold for the maximum number of partitions may be specified. For example, recursive partitioning may be stopped when the area of a partition 250 reaches a specific minimum number of pixels, when subdivision had reached a maximum number of levels, or when a maximum total number or number of partition zones have been created.

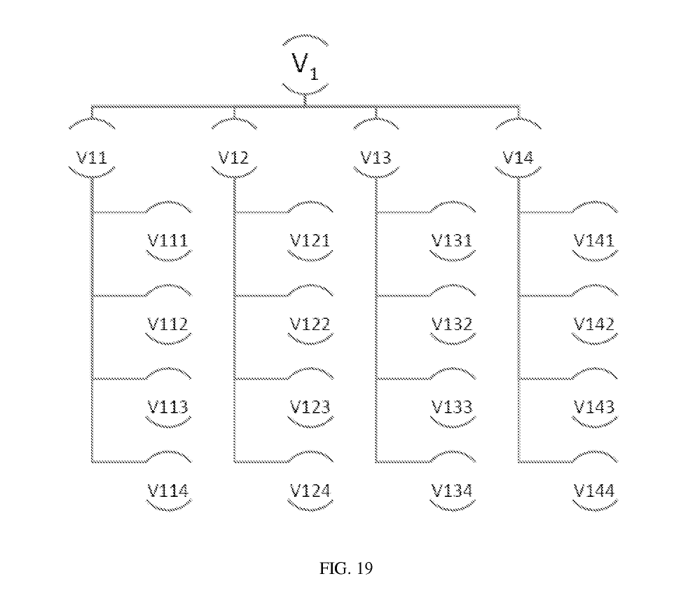

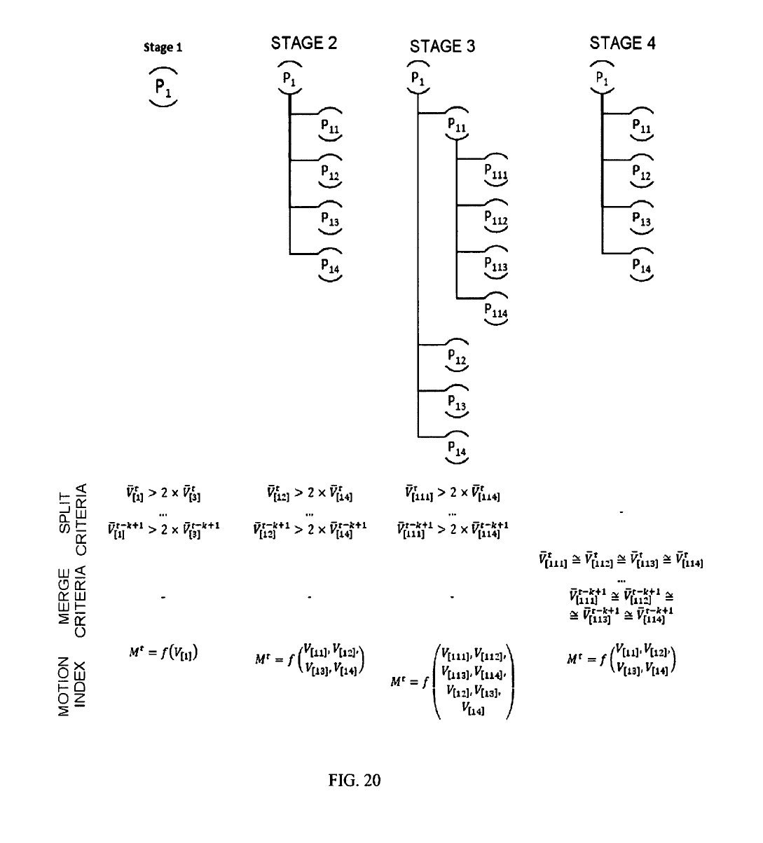

FIG. 19 is an exemplary partition tree diagramming a relationship between candidate partition zones and subzones in a dynamic partitioning system. The arrangements represented by the partition diagrams in FIG. 18 and the partition trees in FIG. 20 are not identical but can still be better understood if they are compared.

An algorithm preferably keeps a short memory of the average velocity for each candidate partitioning level. Average calculation typically starts at the bottom of the partitioning tree. Average velocities for non-final partitions may be recursively obtained from the bottom to the top, according to the formula:

$$( {\overline{V}}_{[ i , j ]}^{t} = \frac{{Σ}_{k = 1}^{4} {\overline{V}}_{[ i , j , k ]}^{t}}{4} )$$

Assuming that maximum partitioning does not allow more than (for example) 3 levels, we will have the vector structure shown in FIG. 19 for each possible partition. Embodiments with no specific limit, or limited to 2, 4, 5, or 6 levels are also possible.

Each node of the partition tree can have a vector that allows the following motion index computation:

$${V}_{[ 1 … n ]} = \{ {V}_{[ 1 … n ]}^{t} , {V}_{[ 1 … n ]}^{t - 1} , … , {V}_{[ 1 … n ]}^{t - k + 1} \}$$

Note that in preferred embodiments this will happen independently of the Motion Index partitioning tree.

With reference to FIG. 20, when a partition zone 250 is subdivided in dynamic partitioning, Optical Flow and the Motion Index begins to be separately computed for each of the new, smaller partition zones. This may be done using historical Optical Flow data from the parent zone (e.g. from the parent's histogram), since the new smaller zones typically will not have their own historical Optical Flow data. After k records, the system checks if at least two of the new partitions have a statistically different average Optical Flow and/or Motion Index. If at least 2 partitions have a statistically different average in k successive frames, the subdivision is retained and Motion Index calculations start to be or continue to be computed for the new partitions (e.g. P11, P12, P13 and P14 in FIG. 20). An overall Motion Index can then be computed based on the average of the individual Motion Indexes obtained for each partition, which in some embodiments is according to

$${M}^{t} = \frac{{Σ}_{l = 1}^{4} {M}_{i}^{t}}{4}$$

the formula:

If the new partition subzones/nodes are different and maintained, each subzone/node can then be subdivided itself, and the process repeated until reaching subdivisions, at each branch of the tree, where the resulting subdivided partitions 250 are not sufficiently different.

If four partitions 250 of the same subzone/node do not include at least one subzone/node with a statistically different average during k consecutive records, they are merged again, and a Motion Index is computed based on the original, larger partition zone.

When determining if subzones are sufficiently different, average comparisons like ANOVA are available but can be computationally intensive. Therefore, in some embodiments, simpler metrics such as “is Optical Flow average for partition (N1, N2, N3, or N4)>2× Optical Flow average for partitions (N1, N2, N3, or N4) the partitions are sufficiently different”. Embodiments where the partitions 250 are deemed sufficiently different if at least one partition is at least 1.1, 1.2, 1.5, 1.8, 2.0, or another amount more than at least one of the other partitions in that set, or than the average of that set or the other subzones in that set, are also possible.

Maintaining Logs of Content Scenarios

In some embodiments, log files are generated and maintained for each use or for selected uses of the system. The logged data can include the content as it was actually displayed in that session, which will vary between sessions based on differing audience instructions. The logs can also include Optical Flow and/or Motion Index values over time, and noise or vocalizations over time.

The data provided by these log files is indexed by: time of event (up to milliseconds); control zone (if the audience is divided into sections); motion direction (left, right, up, down); and the decibel levels generated by the audience. This information may be parsed, and a graph is produced that maps frame by frame activity happening on screen as the audience sees it.

2D and 3D Scenarios

Most aspects of this invention are contemplated for use with both 2D and 3D scenarios. This includes, without limitation, linear navigation, free navigation, point-and-click navigation, masks and filters, Real-Time Participation Tracking (RPT) and Participation Tracking Index, control zones, partition zones, and improved methods for determining and applying Optical Flow vectors and Motion Index values, regardless of any disclosure which happens to be in conjunction with a 3D preferred embodiment.

Hardware

This disclosure may be embodied using a computer system comprised of a processor, memory coupled to the processor, sound card, video card, a video camera 300, a microphone 304, a screen 154, and a computer program or application.

The processor can be any kind of processor that will run the application, including CISC (complex instruction set computing) processors such as an x86 processor, or RISC (Reduced instruction set computing) processors such as an ARM processor. ARM is a family of instruction set architectures for computer processors based on a reduced instruction set computing (RISC) architecture developed by British company ARM Holdings™.

The memory can be any type of memory, including RAM, ROM, EEPROM, magnetic memory such as hard disk drives, solid state drives, flash memory, and optical memory such as Compact Disks, Digital Versatile Disks, and Blu-Ray Disks.

The video camera can be any kind of video camera capable of outputting a digital signal. Specific resolutions and color sensitivity may vary depending on specific implementation purposes. Two, three, four, or more video cameras can be used in conjunction. Wide angle lenses are useful in some applications. Cameras and lenses capable of magnification or zooming will be useful in other arrangements. High quality machine vision cameras with wide angle lenses are included in some preferred embodiments. Standard “webcams”, CCTV, or USB cameras are useful in smaller settings. Cameras selected for high sensitivity in dark or low-light environments are contemplated. The Axis Communications Axis Q1614 Network Camera can be used.

The microphone can be any kind capable of interfacing with the computer sound card. Multiple microphones may be spaced around the viewing area. Dynamic Cardoid microphones may be used.

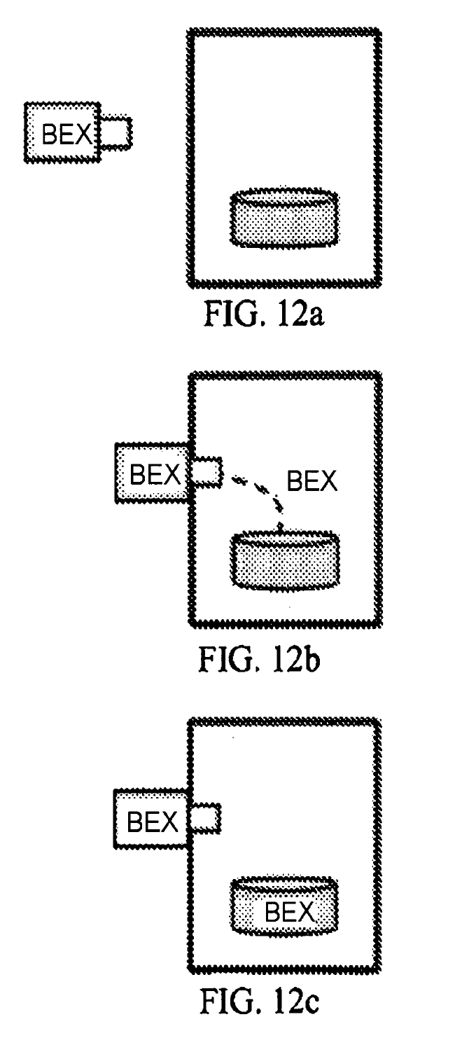

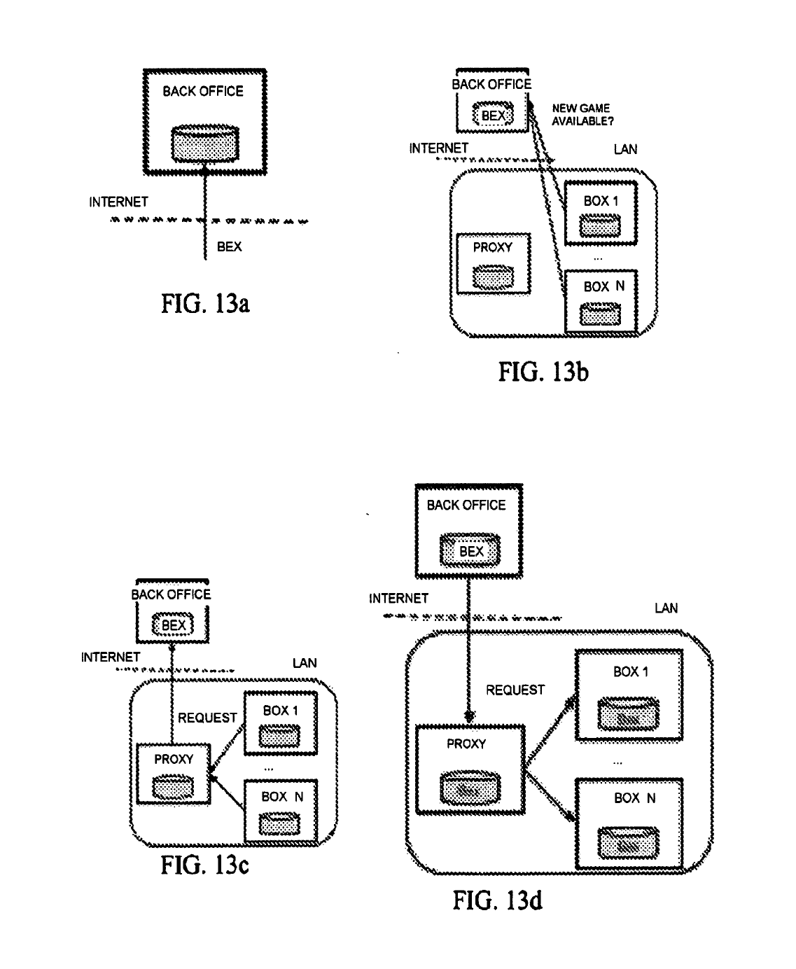

The screen can be any kind of screen that is capable of displaying a video stream. Large electronic screens in venues and projection screens are among the options. In a preferred embodiment the view screen is a large screen similar to a movie theatre screen. The view screen may be a projection screen, or may be a large LCD screen, plasma screen, or other screen which does not require a projector. Alternative embodiments use a smaller screen such as a home TV screen. Multiple screens can also be used, such as embodiments including screens next to and behind the audience to provide a 360° effect. The application is stored in the memory and is executed by the processor, inputting a real-time video stream from the video camera and outputting a video stream to the screen. The system or system updates can be deployed using a USB drive, as shown schematically in FIGS. 12a-12c. The system and updates can also be deployed over a network. See FIGS. 13a-13d. When a new release is ready for deployment it is uploaded as a compressed file (e.g. Bex) to the Back Office. Machines deployed in the field can query a central office or server regularly asking for updates, and if there is new content for them they download it, either directly or through a proxy.

The application does not rely on specific hardware except as noted.

The AEIS system can be embodied in several ways. In one preferred embodiment the system is provided as a turnkey hardware and software system that can turn any big screen environment into a context-aware space for group interaction. Such a system could comprise microphone and camera technology to be positioned in a new or preexisting auditorium, the hardware being linked to a hub server co-located with projection equipment. The system can be provided as a retrofit kit, preferably one that is compatible with preexisting projection technology.

In another preferred embodiment, a software development kit is provided to allow third parties to easily create content for use with the 3D navigation system.

Products for smaller venues and even home use are also contemplated.

No part of this disclosure shall be interpreted as representing what is or is not prior art. This invention includes methods and apparatus for presenting content, especially 3D and panoramic content but also 2D content, to audiences including one or (typically and preferably) more individuals. The invention includes methods of controlling and interacting with media by individuals in an audience, and methods and apparatus for interpreting physical motion by those individuals. The invention includes games and interactive movies controlled by viewing and analyzing the hand, arm, or body motions of audience members, as well as movie theatres, rooms, televisions, home electronics, and computer systems configured for implementing such games and movies. This invention includes software, electronics, and kits for implementing the crowd navigation systems. The invention includes theatres and other venues which are configured to accommodate an audience and allow them to control 3D content. This invention includes partitioning methods and systems using partitioning methods.

While specific embodiments of the invention have been shown and described in detail to illustrate the application of the principles of the invention, it will be understood that the invention may be embodied otherwise without departing from such principles. It will also be understood that the present invention includes any reasonable combination or sub-combination of the features and elements disclosed herein, and any combination of equivalent features. The exemplary embodiments shown herein are presented for the purposes of illustration only and are not meant to limit the scope of the invention. Thus, all the features of all the embodiments disclosed herein are interchangeable to the extent technically and practically feasible, and so that any element of any embodiment may be applied to any of the other embodiments taught or references herein.

What is claimed is:

1. A method of presenting interactive 3D video content to an audience, the method comprising:
providing an audience area for accommodating a plurality of audience members, and a view screen which is visible from the audience area;
providing a video camera which is capable of recording digital video, the video camera being pointed at the audience area, the video camera being functionally connected to a computer for passing video data to the computer;
wherein the computer comprises a memory and a processor, and wherein the computer is functionally connected to the view screen for displaying 3D video content on the view screen;
the method further comprising:
displaying 3D video content on the view screen, the video content on the view screen being at least partially controlled by the computer, the video content comprising simulation of movement through a 3D scenario from a first person perspective, said first person perspective being a camera view;
the video camera capturing digital video of the audience area while the video content is presented on the view screen and while a plurality of audience members are in the audience area, the captured digital video comprising a chronological series of audience images, and the video camera passing the chronological series of audience images on to the computer;
determining Optical Flow vectors for a plurality of different locations in each of the audience images, wherein Optical Flow vectors are determined by a process comprising comparing a location in an audience image with the same location in a chronologically earlier audience image to determine motion at that location;
determining Motion Index values for a chronological series of audiences images, with Motion Index values being determined by a process comprising comparing a current Optical Flow vector with one or more previous Optical Flow vector;
controlling rotation of the camera view using successive Motion Index values;
wherein the 3D video content displayed on the view screen comprises at least one interaction item;
the video camera capturing digital video of lateral gestures by a plurality of audience members in the audience area, the computer determining a plurality of Optical Flow vectors and a plurality of Motion Index values based on said digital video of lateral gestures, and rotating the camera view to one side in response to said Motion Index values;
the interaction item moving from a side of the camera view to a center area of the camera view during said camera rotation, with the camera rotation stopping at a point where the interaction item is in the center area of the camera view in response to a plurality of audience members ending said lateral gesturing; and
after the camera rotation stops, and in response to the interaction item remaining substantially in the center of the camera view for a threshold period of time, displaying a 3D animation of the camera view moving toward the interaction item on the view screen.

2. The method of presenting interactive 3D video content to an audience of claim 1:
wherein the audience area comprises a plurality of seats in at least one of a theater, a cinema, a stadium, a grandstand, a set of bleachers, and an arena.

3. The method of presenting interactive 3D video content to an audience of claim 1:
wherein said lateral gestures by a plurality of audience members comprise lateral arm movements.

4. The method of presenting interactive 3D video content to an audience of claim 1:
wherein the Motion Index values for the audience images are values from −100 to 100;
wherein negative Motion Index values cause the camera view to rotate in a first direction;
wherein positive Motion Index values cause the camera view to rotate in a second direction which is different from the first direction; and
wherein Motion Index values of zero do not cause the camera view to rotate.

5. The method of presenting interactive 3D video content to an audience of claim 1:
wherein the interaction item comprises at least one of a character, a living creature, an object, a vehicle, an intersection, and a building.

6. The method of presenting interactive 3D video content to an audience of claim 1:
wherein said simulation of movement through a 3D scenario from a first person perspective comprises simulation of movement through at least one of a city, a town, a maze, a building, an outdoor landscape, a racecourse, an underwater landscape, and outer space.

7. The method of presenting interactive 3D video content to an audience of claim 1:
wherein the audience area and corresponding audience images are divided into a plurality of control zones;
wherein Optical Flow vectors and Motion Index values are determined separately for each control zone, with said Optical Flow vectors and Motion Index values being determined at least partially based on gestures by different audience members in different respective control zones;
wherein a plurality of camera views are displayed on one or more view screens; and
wherein Motion Index values from different control zones are used to control different respective camera views.

8. The method of presenting interactive 3D video content to an audience of claim 1:
wherein the audience images are divided into a plurality of partition zones;
wherein Optical Flow vectors are separately determined for each partition zone;
wherein Motion Index values are separately calculated for each partition zone;
wherein Average Motion Index values are calculated for each of a plurality of time points, the Average Motion Index values each being an average of the Motion Index values for a plurality of individual partition zones; and
controlling rotation of the camera view using the Average Motion Index.

9. The method of presenting interactive 3D video content to an audience of claim 1:
wherein the audience area comprises areas which are closer to the video camera and areas which are further away from the video camera;
wherein the audience images are divided into a plurality of partition zones, with some partition zones being larger than other partition zones;
wherein a first partition zone corresponding to a first part of the audience area is larger than a second partition zone corresponding a second part of the audience area, and wherein the first part of the audience area is closer to the video camera than the second part of the audience area;
wherein Optical Flow vectors are separately determined for each partition zone; wherein Motion Index values are separately calculated for each partition zone;
wherein Average Motion Index values are calculated for each of a plurality of time points, the Average Motion Index values each being an average of the Motion Index values for a plurality of individual partition zones at a particular time point; and controlling rotation of the camera view using the Average Motion Index values.

10. The method of presenting interactive 3D video content to an audience of claim 1:
wherein, when the computer is processing the audience images, the audience images are divided into a plurality of partition zones, with some partition zones being larger than other partition zones;
wherein the plurality of partition zones are determined by a dynamic partitioning process, the dynamic partitioning process comprising:
a. providing at least a first partition zone;
b. dividing the first partition zone into a plurality of smaller subzones;
c. determining one or more comparison values for each of the subzones, wherein the comparison values are one of Optical Flow vectors and Motion Index values;
d. comparing the comparison values of the subzones;
e. if at least one of the subzones has a comparison value which differs from the comparison value of one or more of the other subzones at the same time point by at least a threshold amount, retaining all of the subzones as independent partition zones; and
f. if none of the subzones have a comparison value which differs from the comparison values of the other subzones at the same time point by at least the threshold amount, re-merging the subzones into the first partition zone;
wherein, during the presenting of 3D video content to a plural audience:
Optical Flow vectors are separately determined for each partition zone;
Motion Index values are separately calculated for each partition zone;
Average Motion Index values are calculated for each of a plurality of time points, the Average Motion Index values each being an average of the Motion Index values for a plurality of individual partition zones at a particular time point; and
controlling rotation of the camera view using the Average Motion Index values.

11. The method of presenting interactive 3D video content to an audience of claim 1:
further comprising applying a force feedback to the camera view which rotates the camera view towards the interaction item independent of the Motion Index values and independent of gestures by audience members.

12. A method of presenting interactive 3D video content to an audience, the method comprising:
providing an audience area for accommodating a plurality of audience members, and a view screen which is visible from the audience area;
providing a video camera which is capable of recording digital video, the video camera being pointed at the audience area, the video camera being functionally connected to a computer for passing video data to the computer;
wherein the computer comprises a memory and a processor, and wherein the computer is functionally connected to the view screen for displaying 3D video content on the view screen;
the method further comprising:
displaying 3D video content on the view screen, the video content on the view screen being at least partially controlled by the computer, the video content comprising simulation of movement through a 3D scenario along a linear path from a first person perspective, said first person perspective being a camera view;
the video camera capturing digital video of the audience area while the video content is presented on the view screen and while a plurality of audience members are in the audience area, the captured digital video comprising a chronological series of audience images, and the video camera passing the chronological series of audience images on to the computer;
determining Optical Flow vectors for a plurality of different locations in each of the audience images, wherein Optical Flow vectors are determined by a process comprising comparing a location in an audience image with the same location in a chronologically earlier audience image to determine motion at that location;
determining Motion Index values for a chronological series of audiences images, with Motion Index values being determined by a process comprising comparing a current Optical Flow vector with one or more previous Optical Flow vectors;
controlling rotation of the camera view using successive Motion Index values; and
the video camera capturing digital video of lateral gestures by a plurality of audience members in the audience area, the computer determining a plurality of Optical Flow vectors and a plurality of Motion Index values based on said digital video of lateral gestures, and rotating the camera view to one side in response to said Motion Index values.

13. The method of presenting interactive 3D video content to an audience of claim 12:
wherein the video content displayed on the view screen comprises simulation of movement through a 3D scenario along a linear path having a forward direction and a backwards direction;
wherein, when the camera view is oriented in the forward direction, the camera view displays movement through the 3D scenario in the forward direction along the path at a first speed; and
wherein, when the camera view is oriented 90° away from the forward direction, the camera view displays one of (i) no movement along the path, and (ii) movement along the path in the forward direction at a speed which is less than the first speed.

14. The method of presenting interactive 3D video content to an audience of claim 12:
wherein the video content displayed on the view screen comprises simulation of movement through a 3D scenario along a linear path having a forward direction and a backwards direction;
wherein, when the camera view is oriented in the forward direction, the camera view displays movement through the 3D scenario in the forward direction along the path; and
wherein, when the camera view is oriented 90° away from the forward direction, the camera view displays no movement along the path; and
wherein, when the camera view is oriented in the backwards direction, the camera view displays movement through the 3D scenario in the backwards direction along the path.

15. The method of presenting interactive 3D video content to an audience of claim 12:
wherein the video content displayed on the view screen comprises simulation of movement through a 3D scenario along a linear path having a forward direction and a backwards direction;
wherein, when the camera view is oriented in the forward direction, the camera view displays movement through the 3D scenario in the forward direction along the path at a first speed; and
wherein, when the camera view is oriented at a diagonal angle intermediate between the forward direction and 90° away from the forward direction, the camera view displays movement along the path in the forward direction at a speed which is less than the first speed.

16. The method of presenting interactive 3D video content to an audience of claim 12:
wherein the video content displayed on the view screen comprises simulation of movement through a 3D scenario along a linear path having a forward direction and a backwards direction;
wherein direction and velocity of movement along the linear path (V_{Camera}) is determined by the angle of the camera view with respect to the forward direction (α_{Camera}), wherein the camera view facing directly in the forward direction is an angle of 0° and the camera view facing in the backwards direction is an angle of 180°; and
wherein V_{Camera} is determined by a method comprising the relationship:
$$VCamera = ( 1 - \frac{α Camera}{90} ) ,$$
with positive V_{Camera} values corresponding to motion in the forward direction and negative V_{Camera} values corresponding to motion in the backward direction.

17. The method of presenting interactive 3D video content to an audience of claim 12:
wherein the 3D video content displayed on the view screen comprises at least one interaction item;
the video camera capturing digital video of lateral gestures by a plurality of audience members in the audience area, the computer determining a plurality of Optical Flow vectors and a plurality of Motion Index values based on said digital video of lateral gestures, and rotating the camera view to one side in response to said Motion Index values;
the camera rotation stopping at a point where the interaction item is in the center area of the camera view in response to a plurality of audience members ending said lateral gesturing; and
after the camera rotation stops, and in response to the interaction item remaining substantially in the center of the camera view for a threshold period of time, displaying a 3D animation of the camera view zooming in towards the interaction item on the view screen, and displaying an enlarged image of the interaction item.

18. The method of presenting interactive 3D video content to an audience of claim 12:
wherein the video content displayed on the view screen comprises simulation of movement through a 3D scenario along a linear path having a forward direction and a backwards direction;
wherein the linear path further comprises at least one intersection, the intersection being a branched location in the linear path where at least three different travel directions are available;
wherein when the 3D scenario reaches an intersection, the audience selects a travel direction by a plurality of audience members gesturing in a rotation direction, the camera view rotating in the rotation direction until the camera view is facing in a selected linear path, at which time a plurality of audience members stop gesturing which in turn causes the camera view rotation to stop; and
after the camera rotation stops, and in response to the camera view facing the selected linear path for at least a threshold period of time: displaying a 3D animation of the camera view moving down the selected linear path on the view screen.

19. The method of presenting interactive 3D video content to an audience of claim 12:
wherein the 3D scenario displayed on the view screen comprises a virtual tour of a real or fictional physical location, with said linear path traversing the physical location.

20. A method of presenting interactive video content to an audience, the method comprising:
providing an audience area for accommodating a plurality of human audience members, and a view screen which is visible from the audience area;
providing a video camera which is capable of recording digital video, the video camera being pointed at the audience area, the video camera being functionally connected to a computer for passing video data to the computer;
wherein the computer is functionally connected to the view screen for displaying video content on the view screen;
the method further comprising:
displaying video content on the view screen, the video content comprising simulation of movement through a video scenario, with a field of vision being displayed on the view screen being a camera view;
while video content is presented on the view screen, the video camera capturing digital video of the audience area comprising a plurality of audience images, which audience images depict gestures by a plurality of audience members in the audience area; and
the method further comprising comparing a current audience image to one or more previous audience images, and rotating the camera view in response to said gestures by a plurality of audience members.

21. The method of presenting interactive video content to an audience of claim 20:
wherein the video content displayed on the view screen comprises at least one interaction item;
wherein a plurality of audience members gesture in a first direction, and the camera view rotates in said first direction in response to said gestures;
wherein said camera view rotation continues until the interaction item is in a center area of the camera view, wherein a plurality of audience members who were gesturing in the first direction stop gesturing and, in response to the stopping of said gesturing, camera rotation stops;
after the camera rotation stops, and in response to the interaction item being substantially in the center of the camera view: displaying an animation of the camera view moving toward the interaction item on the view screen.

22. The method of presenting interactive video content to an audience of claim 20:
wherein the video content comprises 3D video content;
wherein the step of displaying 3D video content on the view screen comprises displaying a simulation of movement through a 3D scenario along a linear path from a first person perspective, with the linear path having a forward direction and a backwards direction; and
wherein a plurality of audience members in the audience area control movement of the camera view along the linear path by using gestures to rotate the camera view with respect to the forward direction.

23. The method of presenting interactive video content to an audience of claim 20:
wherein the audience area comprises areas which are closer to the video camera and areas which are further away from the video camera;
wherein, when the computer is processing the audience images, the audience images are divided into a plurality of partition zones, with some partition zones being larger than other partition zones;
wherein a first partition zone corresponding to a first part of the audience area is larger than a second partition zone corresponding a second part of the audience area, and wherein the first part of the audience area is closer to the video camera than the second part of the audience area;
wherein Optical Flow vectors are separately determined for each partition zone;
wherein Motion Index values are separately calculated for each partition zone;
wherein Average Motion Index values are calculated for a plurality of time points, the Average Motion Index values each being an average of the Motion Index values for a plurality of individual partition zones; and
controlling rotation of the camera view using the Average Motion Index values.

24. The method of presenting interactive video content to an audience of claim 20:
wherein the step of displaying video content on the view screen comprises displaying 2D content.

25. The method of presenting interactive video content to an audience of claim 20:
the method further comprising detecting at least one sound in the audience area, and controlling video content in response to detecting said sound.
